(19) United States
(12) Patent Application Publication
(10) Pub. No.: US 2025/0232155 A1
(43) Pub. Date: Jul. 17, 2025

(54) DEEP OPERATOR NETWORK

(71) Applicant: Brown University, Providence, RI (US)

(72) Inventors: George E. KARNIADAKIS, Newton, MA (US); Lu Lu, Povidence, RI (US)

(21) Appl. No.: 18/275,897

(22) PCT Filed: Feb. 4, 2022
(86) PCT No.: PCT/US2022/015340

§ 371 Date: Aug. 4, 2023

Related U.S. Application Data
(60) Provisional application No. 63/145,783, filed on Feb. 4, 2021.

(51) Int. Cl. G06N 3/045

(52) U.S. Cl. CPC G06N 3/045

(57) ABSTRACT

A method of operating a neural network device includes constructing two sub-networks to encode input functions and location variables separately, and merging the two constructed sub-networks together to compute an output.

### CROSS REFERENCE TO RELATED APPLICATIONS

This application claims benefit from U.S. Provisional Patent Application Ser. No. 63/145,783, filed Feb. 4, 2021, which is incorporated by reference in its entirety.

### STATEMENT REGARDING GOVERNMENT INTEREST

This invention was made with government support under grant number DE-SC00119453 awarded by the U.S. Department of Energy and grant number HR0011-20-9-0062 awarded by the Defense Advanced Research Projects Agency. The government has certain rights in the invention.

### BACKGROUND OF THE INVENTION

The invention generally relates to neural networks, and in particular to a deep operator network.

Over time, mathematical models based on calculus have been employed to both predict and interpret physical phenomena around us, establishing fundamental laws that generalize well. Classical calculus and partial differential equations (PDEs) or their stochastic variants have been effective in the era of the “pursuit of simplicity,” but they may be inefficient or even inadequate to represent complex inter-connected systems or systems of systems with non-local interactions. Some of the hardest problems in science rely on being able to solve and evaluate complex ordinary or partial differential equations and integrals. While this is not an issue for simple systems where the equations are well studied and analytical solutions exist, the majority of open problems do not share these properties. In the past, the equations are often approximated from noisy experimental data, and their evaluation around new data points is obtained from running complex numerical simulations on large supercomputers; both expensive options, computationally and financially.

What is needed is a system that can both estimate the equations from data, and evaluate them around new data points in a fast and reliable way.

### SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In an aspect, the invention features a method of operating a neural network device including constructing two sub-networks to encode input functions and location variables separately, and merging the two constructed sub-networks together to compute an output.

In another aspect, the invention features a network including a first neural network configured to encode a discrete function space, and a second neural network configured to encode a domain of output functions.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

These and other features, aspects, and advantages of the present invention will become better understood with reference to the following description, appended claims, and accompanying drawings where:

FIGS. 1A, 1B, 1C and 1D illustrate problem setup and architectures of DeepONets.

FIGS. 2A, 2B, 2C and 2D are exemplary graphs.

FIGS. 3A and 3B are exemplary graphs.

FIGS. 4A, 413, 4C and 4D are exemplary graphs.

FIGS. 5A and 5B are exemplary graphs.

FIGS. 6A and 6B are exemplary graphs.

FIG. 6C illustrates an exemplary system.

FIG. 7A-7F are exemplary graphs.

FIG. 8 is an exemplary graph.

FIG. 9A-9C are exemplary graphs.

FIGS. 10A, 1013 and 10C are exemplary graphs.

FIG. 11A-11D are exemplary graphs.

FIG. 12A-12B are exemplary graphs.

FIG. 13A-13B are exemplary graphs.

FIG. 14 is an exemplary graph.

FIG. 15A-15D are exemplary graphs.

FIG. 16 is an exemplary graph.

FIG. 17 is an exemplary graph.

FIG. 18 is an exemplary graph.

FIG. 19 is an exemplary graph.

FIG. 20 is an exemplary graph.

FIGS. 21-25 illustrate exemplary tables.

FIG. 26 illustrates DeepONet principles.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

One of the fundamental issues in machine learning research is system identification from data, and how to design deep neural networks (DNNs) that could represent and discover nonlinear operators, mapping input functions into output functions. These operators can be of explicit type, e.g., the Laplace transform, or of implicit type, e.g., solution operators of partial differential equations (PDEs). For solution operators, the inputs to DNN could be functions representing boundary conditions selected from a properly designed input space V. Implicit type operators may also describe systems for which we do not have any mathematical knowledge of their form, e.g., in social dynamics, although we do not consider such cases in the present work.

In literature, two types of implicit operators have been considered, i.e., dynamical systems, in the form of ordinary differential equations (ODEs) or in the form of PDEs, as follows:

For dynamical systems, different network architectures have been employed, including feed-forward NNs (FNNs), recurrent NNs (RNNs), reservoir computing, residual networks, autoencoders, neural ordinary differential equations, neural jump stochastic differential equations, and many others. However, they are only able to predict the evolution of a specific system (e.g., a Hamiltonian system) rather than identifying the system behavior for new unseen input signals.

In learning operators from PDEs with structured data, some works treat the input and output function as an image and then use convolutional NNs (CNNs) to learn the image-to-image mapping G, but this approach can be only applied to particular types of problems, where the sensors of the input function u are distributed on an equispaced grid. Also, the training data must include all the G(u)(y) values with y also on an equispaced grid.

For unstructured data, a modified CNN based on generalized moving least squares or graph kernel networks can be used to approximate specific operators. However, they are not able to learn general nonlinear operators. Also, some PDEs can be parameterized by unknown coefficients or an unknown forcing term, and then the unknown parts are identified from data. However, not all PDEs can be well parameterized.

Symbolic mathematics have also been applied to represent PDEs while accuracy and robustness still need to be addressed.

In this work, we propose a new deep learning framework, DeepONet, to learn diverse continuous nonlinear operators without the aforementioned constraints. DeepONet is inspired directly by the theory that guarantees small approximation error (i.e., the error between the target operator and the class of neural networks of a given finite-size architecture). Moreover, the specific architectures we introduce exhibit small generalization errors (i.e., the error of a neural network for previously unseen data) for diverse applications that we systematically study herein.

Our proposal of approximating functionals and nonlinear operators with NNs goes beyond the universal function approximation and supervised data, or using the idea of physics-informed neural networks (PINNs).

Neural networks (NNs) are universal approximators of continuous functions. A NN with a single hidden layer can approximate accurately any nonlinear continuous operator. This universal approximation of operators is suggestive of the potential of NNs in learning from scattered data any continuous operator or complex system. Fully described below is a new NN with small generalization error, herein referred to as a deep operator network (“DeepONet”). As is described below, DeepONet includes a NN for encoding the discrete input function space (i.e., branch net) and another NN for encoding the domain of the output functions (i.e., trunk net). DeepONet can learn various explicit operators, e.g., integrals and fractional Laplacians, as well as implicit operators that represent deterministic and stochastic differential equations.

While calculus has served science well, new fundamental developments are slow and have not established any governing principles in some fields, e.g., in the emerging field of social dynamics. In the era of artificial intelligence and data analytics, the question is then if there are any more expressive representations that can be employed to accelerate scientific discovery. Classical calculus and partial differential equations (PDEs) or their stochastic variants, taught diligently in colleges around the globe, have been effective in the era of the “pursuit of simplicity,” but they may be inefficient or even inadequate to represent complex inter-connected systems or systems of systems with non-local interactions.

Here, we formulate an alternative calculus-agnostic simple and fast way of describing an operator and its dynamics implicitly based on a given data set. More broadly, with the anticipated frequent human-robot interactions in the not-too-distant future, we address the question on how to best educate the new generations on quantitative inference and how to endow new robots with the required intelligence. Following the current paradigm, one approach would be to teach robots calculus, i.e., one integral or differential operator at a time, and train them to synthesize and solve such PDEs at blazing speeds to make quantitative decisions, sense their environment, and communicate with humans; however, this seems computationally prohibitive. An alternative direction is to train them using new means in learning nonlinear operators and functionals that compactly express very complex dynamics without the need for resorting to prior knowledge of 17th-century calculus. Though the training of the new DNNs could be laborious, the computational expense for training is not a limiting factor, as for each problem we only need to train the network once, and the training is performed offline.

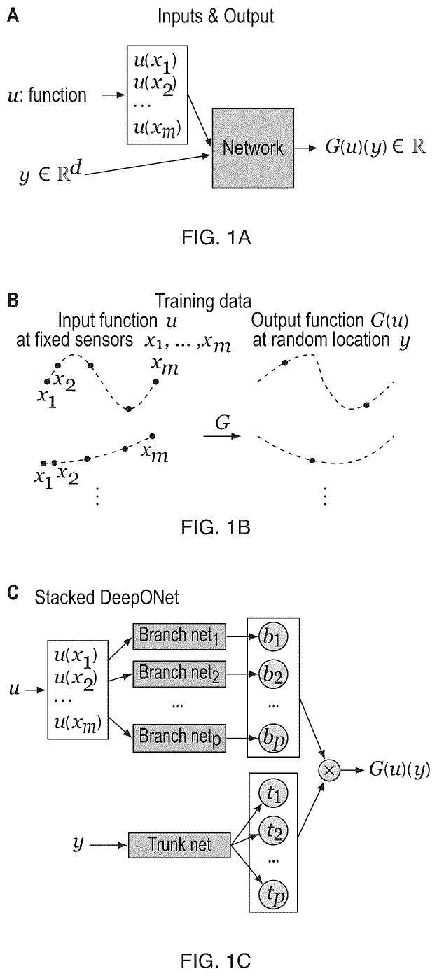

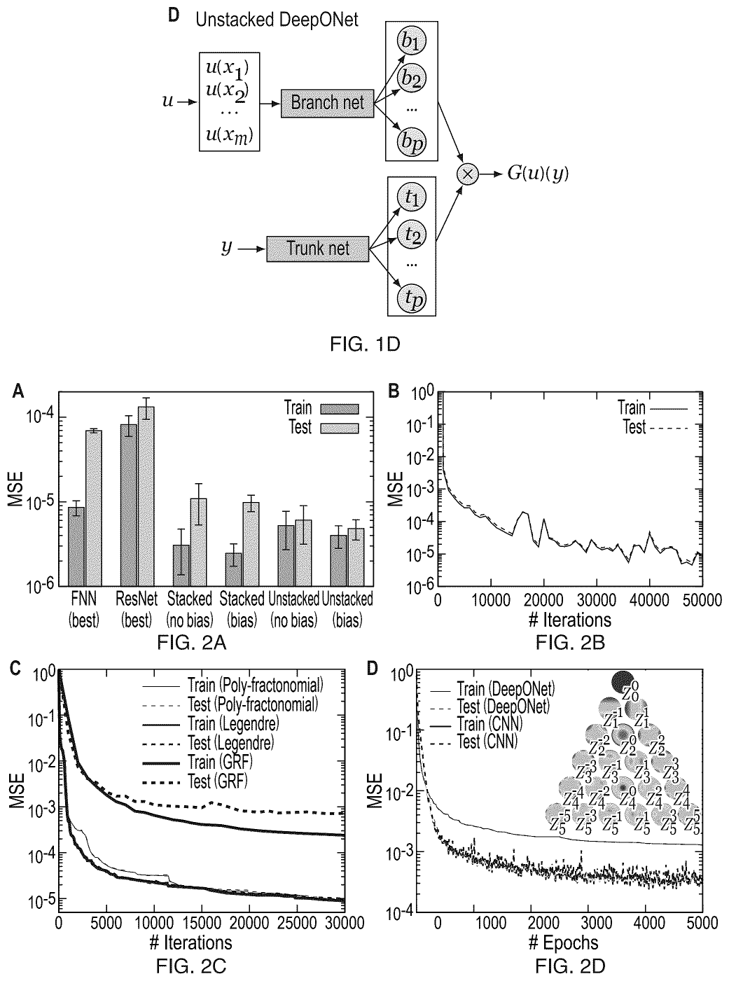

Here we develop new types of NNs that go beyond the universal function approximation and supervised data, and approximate functionals and nonlinear operators instead. As a first step, we resort to the universal operator approximation theorem, which states that a NN with a single hidden layer can approximate accurately any nonlinear continuous functional (a mapping from a space of functions into the real numbers) or (nonlinear) operator (a mapping from a space of functions into another space of functions). To wit, let G be an operator taking an input function u with G(u) the corresponding output function. For any point y in the domain of G(u), the output G(u)(y) is a real number. Hence, the network takes inputs composed of two parts: u and y, and outputs G(u)(y) (FIG. 1A). Although our goal is to learn operators, which take a function as input, we have to represent these input functions discretely, so that network approximations can be applied. Here, we explore different representations of the input function, with the simplest one based on the function values at a sufficient but finite number of locations {x₁, x₂, . . . , xₘ}, which we call “sensors” (FIG. 1A). There are other ways to represent a function, e.g., with spectral expansions or as an image, and we show these in the examples below. In particular, we describe that we can design NNs that can represent accurately both explicit known operators, e.g., integrals, transforms, fractional derivatives and fractional Laplacians, as well as implicit operators known from classical calculus such as nonlinear, deterministic and stochastic ordinary and partial differential equations. The proposed NNs generalizes well, so given unseen functions they predict the action of the operator or predict the solution of the dynamical system accurately.

Theorem 1 (Universal Approximation Theorem for Operator). Suppose that σ is a continuous non-polynomial function, X is a Banach Space, K₁⊂X, K₂⊂R^{d} are two compact sets in X and R^{d}, respectively, V is a compact set in C(K₁), G is a nonlinear continuous operator, which maps V into C(K₂). Then for any ε>0, there are positive integers n, p, m, constants

$$\text{?} , \text{?} , \text{?} , \text{?} ∈ ℝ , \text{?} ∈ {ℝ}^{d} , {x}_{j} ∈ {K}_{1} , i = 1 , … n , k = 1 , … , p , j = 1 , … , m , \qquad ( 1 )$$

$$such that$$

$$\vert G ( u ) ( y ) - {\underbrace{{\sum }_{k = 1}^{p} {\sum }_{i = 1}^{n} \text{?} ( {\sum }_{j = 1}^{m} \text{?} u ( {x}_{j} ) + \text{?} )}}_{\text{?}} {\underbrace{σ ( \text{?} \cdot y + \text{?} )}}_{\text{?}} \vert < \text{?}$$

$$holds for all \text{?} ∈ V and y ∈ {K}_{2} .$$

$$\text{?} \text{indicates text missing or illegible when filed}$$

This approximation theorem is indicative of the potential application of neural networks to learn nonlinear operators from data, i.e., similar to standard NN where we learn functions from data. However, this theorem does not inform us how to learn operators efficiently. The overall accuracy of NNs can be characterized by dividing the total error into three main types: approximation, optimization, and generalization errors. The universal approximation theorem only guarantees a small approximation error for a sufficiently large network, but it does not consider the important optimization and generalization errors at all, which are often dominant contributions to the total error in practice. Useful networks should be easy to train, i.e., to exhibit small optimization error, and generalize well to unseen data, i.e., to exhibit small generalization error.

To demonstrate the capability and effectiveness of learning nonlinear operators by neural networks, we setup the problem as general as possible by using the weakest possible constraints on the sensors and training dataset. Specifically, the only condition required is that the sensor locations {x₁, x₂, . . . , xₘ} are the same but not necessarily on a lattice for all input functions u, while we do not enforce any constraints on the output locations y (FIG. 1B). However, even this constraint can be lifted and it is only used here for computational expediency. We provide a specific new network architecture, the deep operator network (“DeepONet”), to achieve small total errors. We demonstrate that unlike fully-connected neural networks (FNNs), DeepONet significantly improves generalization based on a design of two sub-networks, the branch net for the input function and the trunk-net for the locations to evaluate the output function. The key point is that we discover a new operator G as a NN, which is able to make inferences for quantities of interest given new and unseen data. If we wish to further interpret the type of operator G using the familiar classical calculus, we can project the results of G(u)(y) onto a dictionary containing first- or higher-order derivatives, gradients, Laplacians, etc., as it is done currently with existing regression techniques. Returning to the aforementioned example, using the initial conditions as the function u(x) we can train the operator G offline and then we can predict the dynamics for new unseen boundary conditions with error 10⁻⁴ or less at a fraction of a second.

We consider two types of implicit operators, i.e., dynamical systems (e.g., in the form of ordinary differential equations, ODEs) and partial differential equations (PDEs). Some works used standard NNs to identify dynamical systems, but they only considered systems described by difference equations. Some other works predict the evolution of a specific dynamical system rather than identifying the system behavior for new unseen input signals. The network architectures they employed includes FNNs, recurrent neural networks (RNNs), reservoir computing, residual networks, autoencoder, neural ordinary differential equations, and neural jump stochastic differential equations. For identifying PDEs, some works treat the input and output function as an image, and then use convolutional neural networks (CNNs) to learn the image-to-image mapping, but this approach can be only applied to the particular type of problems, where the sensors of the input function u are distributed on an equispaced grid, and the training data must include all the G(u)(y) values with y also on an equispaced grid. In another approach without this restriction, PDEs are parameterized by unknown coefficients, and then only the coefficient values are identified from data. Alternatively, a generalized CNN based on generalized moving least squares can be used for unstructured data, but it can only approximate local operators and is not able to learn other operators like an integral operator. In the examples we present below, we explore other representations of the discrete function input space.

DeepONet architecture. We focus on learning operators in a more general setting, where the only requirement for the training dataset is the consistency of the sensors {x₁, x₂, . . . , xₘ} for input functions. In this general setting, the network inputs include two separate components: [u(x₁), u(x₂), . . . , u(xₘ)]^{T} and y (FIG. 1A), and the goal is to achieve good performance by designing the network architecture. One straightforward solution is to directly employ a classical network, such as FNN, CNN or RNN, and concatenate two inputs together as the network input, i.e., [u(x₁), u(x₂), . . . , u(xₘ), y]^{T}. However, the input does not have any specific structure, and thus it is not meaningful to choose networks like CNN or RNN; here we use a FNN and ResnNet as the baseline models. To compare DeepONets with additional models, we also consider CNN or RNN as the baselines in a few examples for specific problems and datasets.

In high dimensional problems, y is a vector with d components, so the dimension of y does not match the dimension of u(x₁) for i=1, 2, . . . , m any more. This also prevents us from treating u(x₁) and y equally, and thus at least two sub-networks are needed to handle [u(x₁), u(x₂), . . . , u(xₘ)]^{T} and y separately. Although the universal approximation theorem (Theorem 1) does not have any guarantee on the total error, it still provides us with a network structure in Eq. (1). Theorem 1 only considers a shallow network with one hidden layer, so we extend it to deep networks to gain expressivity. Our architecture is shown in FIG. 1C. First there is a “trunk” network, which takes y as the input and outputs [t₁, t₂, . . . , tₚ]^{T}∈R^{p}. In addition to the trunk network, there are p “branch” networks, and each of them takes [u(x₁), u(x₂), . . . , u(xₘ)]^{T} as the input and outputs a scalar bₖ∈R for k=1, 2, . . . , p. We merge them together as in Eq. (1): G(u)(y)≈Σₖ₌1^{p} bₖ tₖ. We note that the trunk network also applies activation functions in the last layer, i.e., tₖ=σ(⋅) for k=1, 2, . . . , p, and thus this trunk-branch network can also be seen as a trunk network with each weight in the last layer parameterized by another branch network instead of the classical single variable. We also note that in Eq. (1) the last layer of each bₖ branch network does not have bias. Although bias is not included in Theorem 1, adding bias may increase the performance by reducing the generalization error. In addition to adding bias to the branch networks, we also add a bias b₀∈R in the last stage: G(u)(y)≈Σₖ₌₁^{p} bₖ tₖ+b₀.

In practice, p is at least of the order of 10, and using lots of branch networks is inefficient. Hence, we merge all the branch networks into one single branch network (FIG. 1D), i.e., a single branch network outputs a vector [b₁, b₂, . . . , bₚ]^{T}∈R^{p}. In the first DeepONet (FIG. 1C), there are p branch networks stacked parallel, so we name it “stacked DeepONet”, while we refer to the second DeepONet (FIG. 1D) as “unstacked DeepONet.” All versions of DeepONets are implemented in DeepXDE, a user-friendly Python library designed for scientific machine learning. The loss function we used is the mean squared error (MSE) between the true value of G(u)(y) and the network prediction for the input ([u(x₁), u(x₂), . . . , u(xₘ)], y).

DeepONet is a high-level network architecture without defining the architectures of its inner trunk and branch networks. To demonstrate the capability and good performance of DeepONet alone, we choose the simplest FNN as the architectures of the sub-networks in this detailed description. It is possible that using convolutional layers we could further improve accuracy. However, convolutional layers usually work for square domains with {x₁, x₂, . . . , xₘ} on a equispaced grid, so as alternative and for a more general setting we may use the “attention” mechanism.

Data generation. The input function u(x) plays an important role in operator identification; here, we mainly consider the following function spaces: Gaussian random fields (GRF), spectral representations, and formulating the input functions as images.

In order to estimate how many sensors are required to achieve accuracy F, we consider the following ODE system:

$$Problem 1 \{ \begin{matrix}\text{?} s ( x ) = g ( s ( x ) , u ( x ) , x ) \\ s ( a ) = {s}_{0}\end{matrix} , \qquad ( 2 )$$

$$\text{?} \text{indicates text missing or illegible when filed}$$

where u∈V (a compact subset of C[a, b]) is the input signal, and s:[a, b]→R^{K} is the solution of system (2) serving as the output signal.

Let G be the operator mapping the input u to the output s, i.e., G(u) satisfies

$$G ( u ) ( x ) = {s}_{0} + {\int }_{a}^{x} g ( G ( u ) ( t ) , u ( t ) , t ) dt .$$

Now, we choose uniformly m+1 points xⱼ=a+j(b−a)/m, j=0, 1, . . . , m from [a, b], and define the function uₘ (x) as follows:

$${u}_{m} ( x ) = u ( {x}_{j} ) + \frac{u ( {x}_{j + 1} ) - u ( {x}_{j} )}{{x}_{j + 1} - {x}_{j}} ( x - {x}_{j} ) , {x}_{j} \leq \text{?} \leq {x}_{j + 1} , j = 0 , 1 , … , m - 1.$$

$$\text{?} \text{indicates text missing or illegible when filed}$$

Denote the operator mapping u to uₘ by Lₘ, and let Uₘ={Lₘ(u)|u∈V}, which is a compact subset of C[a, b], since V is compact and continuous operator Lₘ keeps the compactness. Obviously, Wₘ:=V∪Uₘ as the union of two compact sets is also compact. Then, set W:=Uᵢ=1^{∞}Wᵢ, and the Lemma points out that W is still a compact set. Since G is a continuous operator, G(W) is compact in C([a, b]; R^{K}). For convenience of analysis, we assume that g(s, u, x) satisfies the Lipschitz condition with respect to s and u on G(W)×W, i.e., there is a constant c>0 such that

$$\begin{matrix}{‖ g ( {s}_{1} , u , x ) - g ( {s}_{2} , u , x ) ‖}_{2} \leq \text{?} {‖ {s}_{1} - {s}_{2} ‖}_{2} \\ {‖ g ( s , {u}_{1} , x ) - g ( s , {u}_{2} , x ) ‖}_{2} \leq \text{?} \vert {u}_{1} - {u}_{2} \vert\end{matrix} .$$

$$\text{?} \text{indicates text missing or illegible when filed}$$

Note that this condition is easy to achieve, for instance, as long as g is differentiable with respect to s and u on G(W)×W.

For u∈V, uₘ∈Uₘ, there exists a constant κ(m, V) depending on m and compact space V, such that

$$max \text{?} \vert u ( x ) - {u}_{m} ( x ) \vert \leq κ ( m , V ) , κ ( m , V ) \to 0 \text{?} m \to ∝ . \qquad ( 3 )$$

$$\text{?} \text{indicates text missing or illegible when filed}$$

When V is GRF with the Gaussian kernel, we have κ(m, V)˜1/m² l². Based on these concepts, we have the following theorem.

Theorem 2. Suppose that m is a positive integer making c(b−a)κ(m, V)e^{c(b-a)} less than ε, then for any d∈[a, b], there exist W₁∈R^{n×(m+1)}, b₁∈R^{m+1}, W₂∈R^{K×n}, b₂∈R^{K}, such that

$${‖ G ( u ) ( d ) - {W}_{2} \cdot σ ( {W}_{1} \cdot {[ u ( {x}_{0} ) … u ( {x}_{m} ) ]}^{T} + {b}_{1} ) + {b}_{2} ) ‖}_{2} < ε$$

$$holds for all u ∈ V .$$

Learning explicit operators. First, we consider a pedagogical example described by

$$\frac{ds ( x )}{dx} = g ( \text{?} ( x ) , u ( x ) , x ) , x ∈ ( 0 , 1 ] ,$$

$$\text{?} \text{indicates text missing or illegible when filed}$$

with an initial condition (IC) s(0)=0. Our goal is to predict s(x) over the whole domain [0, 1] for any u(x). We first consider a linear problem by choosing g(s(x), u(x), x)=u(x), which is equivalent to learning the antiderivative operator. That is,

$$( 4 )$$

$$\begin{matrix}\begin{matrix}Problem 1. A & \frac{d \text{?} ( x )}{dx}\end{matrix} = u ( x ) , & \begin{matrix}and & G :\end{matrix}\end{matrix} u ( x ) ↦ \text{?} ( x ) = {s}_{0} + \int \text{?} u ( r ) dr , \text{} x ∈ [ 0 , 1 ] \text{?}$$

$$\text{?} \text{indicates text missing or illegible when filed}$$

We train FNNs and residual neural networks (ResNets) to learn the antiderivative operator. The p-values of two-sided T-tests indicate whether the test error of the unstacked DeepONet with bias is significantly smaller than that of other networks.

| Network | Training MSE | | | | Test MSE | | | | p-value |
|---|---|---|---|---|---|---|---|---|---|
| FNN (best) | 8.6 | 10⁻⁶ | 1.7 | 10⁻⁶ | 7.0 | 10⁻⁵ | 4.1 | 10⁻⁶ | 0.000 |
| ResNet (best) | 8.2 | 10⁻⁵ | 2.3 | 10⁻⁵ | 1.3 | 10⁻⁴ | 3.8 | 10⁻⁵ | 0.000 |
| Seq2Seq (best) | 2.2 | 10⁻⁶ | 1.7 | 10⁻⁶ | 8.9 | 10⁻⁶ | 5.7 | 10⁻⁶ | 0.002 |
| Seq2Seq 10 (best) | 1.6 | 10⁻⁶ | 1.4 | 10⁻⁶ | 2.6 | 10⁻⁶ | 1.9 | 10⁻⁶ | 0.391 |
| Stacked (no bias) | 3.1 | 10⁻⁶ | 1.7 | 10⁻⁶ | 1.1 | 10⁻⁵ | 5.6 | 10⁻⁶ | 0.000 |
| Stacked (bias) | 2.4 | 10⁻⁶ | 7.3 | 10⁻⁷ | 9.8 | 10⁻ [symbol] | 2.2 | 10⁻ [symbol] | 0.000 |
| Unstacked (no bias) | 1.7 | 10⁻⁶ | 4.5 | 10⁻⁷ | 2.3 | 10⁻⁶ | 5.7 | 10⁻⁷ | 0.386 |
| Unstacked (bias) | 1.6 | 10⁻⁶ | 6.0 | 10⁻⁷ | 2.0 | 10⁻⁶ | 6.2 | 10⁻⁷ | — |

[symbol]

indicates data missing or illegible when filed

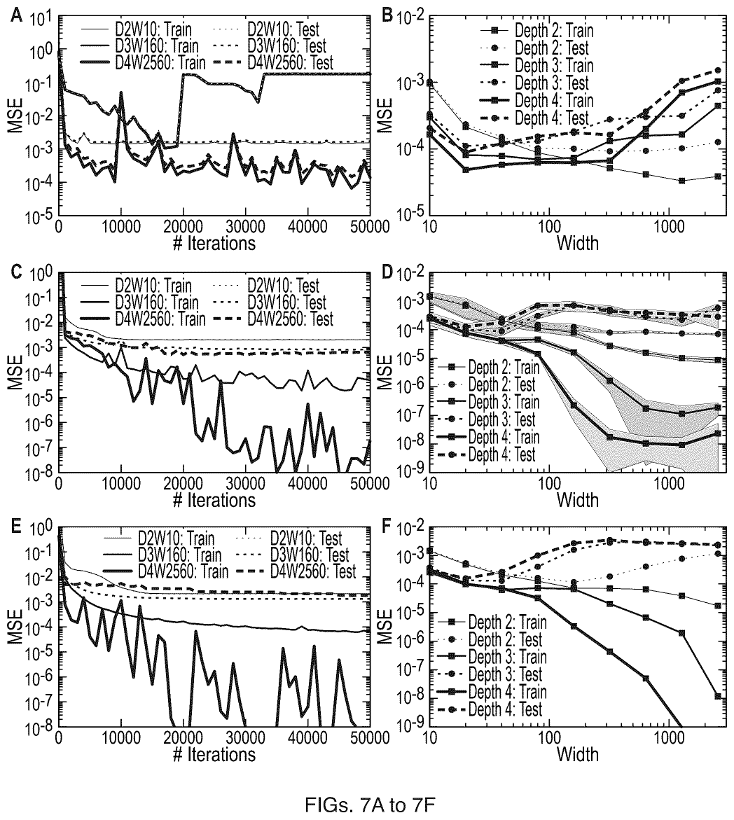

To obtain the best performance of FNNs, we grid search the three hyperparameters: depth from 2 to 4, width from 10 to 2560, and learning rate from 0.0001 to 0.01. The mean squared errors (MSE) of the test dataset with learning rate 0.01, 0.001, and 0.0001 are shown in FIGS. 7A-7D. Although we only choose depth up to 4, the results show that increasing the depth further does not improve the test error. Among all these hyperparameters, the smallest test error ˜7×10⁻⁵ is obtained for the network with depth 2, width 2560, and learning rate 0.001. We observe that when the network is small, the training error is large and the generalization error (the difference between test error and training error) is small, due to small expressivity. When the network size increases, the training error decreases, but the generalization error increases. We stop the training before FNNs reach the overfitting region, where the test error increases. Similarly, for ResNets, we grid search the two hyperparameters: the number of residual blocks from 1 to 5, and width from 10 to 320. We note that one residual block includes two dense layers with a shortcut connection, and each ResNet has one hidden layer before the first residual bock and one hidden layer after the last residual block, and thus a ResNet has in total (3+2 #residual block) layers. We choose the learning rate as 0.001 based on the previous results of FNNs. Among all these hyperparameters, the smallest test error ˜1×10⁻⁴ is obtained for the ResNet with 1 residual block and width 20.

Compared to FNNs and ResNets, DeepONets have much smaller generalization error and thus smaller test error. Here we do not aim to find the best hyperparameters, and only test the performance of the two DeepONets listed Table S3. The training trajectory of an unstacked DeepONet with bias is shown in FIG. 2B, and the generalization error is negligible. We observe that for both stacked and unstacked DeepONets, adding bias to branch networks reduces both training and test errors (FIG. 2A); DeepONets with bias also have smaller uncertainty, i.e., they are more stable for training from random initialization (FIG. 2A). Compared to stacked DeepONets, although unstacked DeepONets have larger training error, the test error is smaller, due to the smaller generalization error. Therefore, unstacked DeepONets with bias achieve the best performance. In addition, unstacked DeepONets have fewer number of parameters than stacked DeepONets, and thus can be trained faster using much less memory.

In addition to the aforementioned integral operator, we consider integro-differential operators, namely, fractional differential operators, in order to demonstrate the flexibility of DeepONets to learn more complicated operators. The first fractional differential operator we learn is the 1D Caputo fractional derivative:

$$\begin{matrix}Problem 2 & G ( u ) ( y , α\end{matrix} ) : u ( x ) ↦ \text{?} ( y , α ) = \frac{1}{Γ ( 1 - α )} \int \text{?} ( y - τ ) \text{?} ( τ ) d τ , y ∈ [ 0 , 1 ] , α ∈ ( 0 , 1 ) ,$$

$$\text{?} \text{indicates text missing or illegible when filed}$$

where α and u′(⋅) are the fractional order and first derivative of u, respectively. The domain of output function now includes two variables y and α. We concatenate y and α to form an augmented ŷ=[y, α]^{T} and then feed ŷ to the trunk net. We consider the influence of different V spaces on the generalization error of DeepONets. These spaces include two orthogonal polynomial spaces spanned by poly-factonomials and Legendre polynomials, as well as the GRF. FIG. 2C shows the generalization errors for the three different V spaces. We see that small generalization errors are achieved for all of the cases. The generalization error for GRF is slightly larger than those for orthogonal polynomial spaces, since for GPR we select different characteristic lengths l's in the RBF kernel for training and test sets.

Next, we will test DeepONets for the situation where the training dataset and test dataset are not sampled from the same function space. Specifically, the input functions in the training dataset are sampled from the space of GRF with the covariance kernel kₗ(x₁, x₂)=exp(−∥x₁−x₂∥²=²/2l²), where l is the length-scale parameter. After the network is trained, instead of testing functions also in this space, we will always use the functions sampled from the space of GRF with 1=0.1 for testing. To quantify the difference between two GRF spaces of different correlation lengths, we use the 2-Wasserstein (W2) metric to measure their distance. When 1 is large, the W2 metric is large, and the test error is also large. When 1 is smaller, the W2 metric and test error become smaller. If 1=0.1, the training and test spaces are the same, and thus the W2 metric is 0. It is interesting that the test MSE grows exponentially with respect to the W2 metric.

The second fractional differential operator we learn is the 2D Riesz fractional Laplacian:

$$\begin{matrix}Problem 3 & G ( u )\end{matrix} ( y , α ) \text{?} u ( x ) ↦ \text{?} ( y , α ) = \frac{2 \text{?} Γ ( 1 + \text{?} )}{π \vert Γ ( - \text{?} ) \vert} \times p . v . \int \text{?} \frac{u ( y ) - u ( \text{?} )}{‖ y - \text{?} ‖ \text{?}} dr , α ∈ ( 0 , 2 ) ,$$

$$\text{?} \text{indicates text missing or illegible when filed}$$

where .v.″ means principle value. The input and out functions are both assumed to be identically zero outside of a unit disk centered at the origin. The 2D fractional Laplacian reduces to standard Laplacian Δ as the fractional order a goes to two. For learning this operator, we specify the V space to be the orthogonal space spanned by the Zernike polynomials, which are commonly used to generate or approximate functions defined on a unit disk. FIG. 2D displays the first 21 Zernike polynomials. Importantly, we consider two different NN architectures: trunk and unstacked branch nets versus CNNs. For the first architecture, in a similar manner for handling the 1D Caputo derivative case, we feed the augmented ŷ=[y, α] to the trunk net. For the CNN architecture, we rearrange the values of input and output functions to 2D images in which “pixel” (or function) values are attached to a lattice in the polar coordinate. We first utilize a CNN as an encoder to extract the features of the input image, which reduces the high-dimensional input space to a low-dimensional latent space, and then we employ another CNN as a decoder to map the vector in the latent space to the output space. To accommodate the extra parameter α, we set the image consisting of values of G(y, αₖ) for k-th α as the k-th channel of the output image. As such, we obtain a multi-channel output image. We observe from FIG. 2D that both architectures yield small generalization errors. Moreover, the CNN architecture gains slightly higher operator approximation accuracy than the branch-trunk nets. This is because the former sufficiently takes advantage of the spatial structure of the training data. Nevertheless, DeepONet is more flexible than CNN for unstructured data as we commented in preceding paragraphs.

An important question for the effectiveness of DeepONet is how fast it learns new operators. We investigate this question by learning a system of ODEs first and subsequently a nonlinear PDE. First, we consider the motion of a gravity pendulum with an external force described by

$$\begin{matrix}\begin{matrix}Problem 1. B & \frac{d \text{?}}{dt}\end{matrix} = \text{?} , & \frac{d \text{?}}{dt} = - k sin\end{matrix} \text{?} + u ( t ) ,$$

$$\text{?} \text{indicates text missing or illegible when filed}$$

with an initial condition s(0)=0, and k determined by the acceleration due to gravity and the length of the pendulum. This problem is characterized by three factors: (1) k, (2) maximum prediction time T, and (3) input function space. The accuracy of learned networks is determined by four factors: (1) the number of sensor points m; (2) training dataset size; (3) network architecture, (4) optimizer. Here we focus on the convergence rate of the training process.

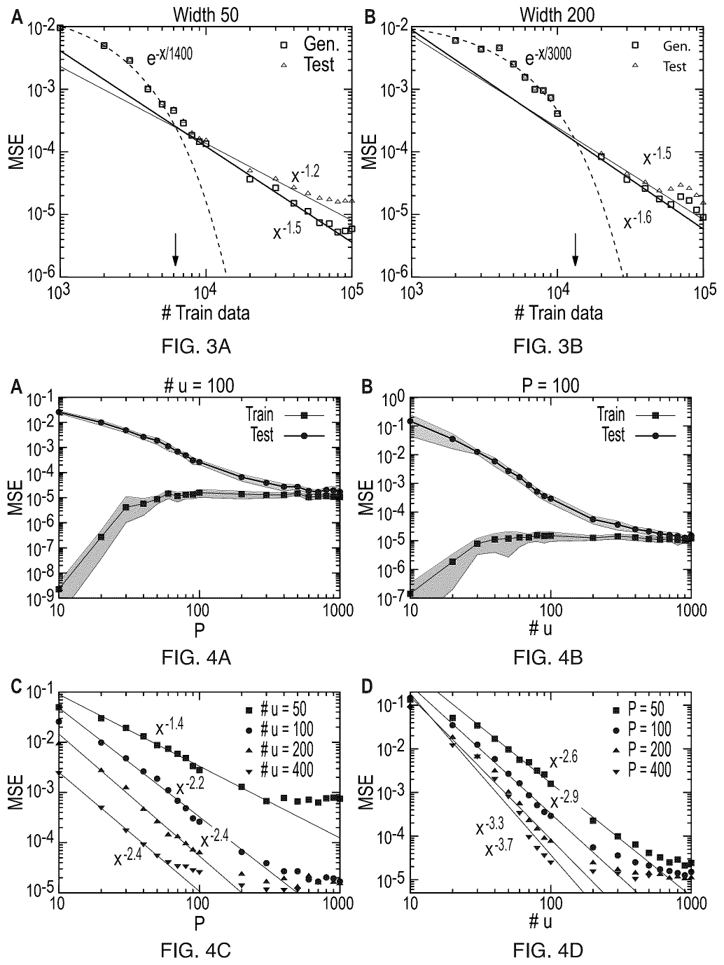

The test and generalization errors of networks with different width are shown in FIGS. 3A and 3B. It is surprising that the test and generalization errors have exponential convergence for small training dataset size. Even for a large dataset, the polynomial convergence rates are still higher than the classical x^{-0.5} in the learning theory. This fast convergence reveals that DeepONets learn exponentially fast, especially in the region of small dataset. Moreover, the transition point from exponential to polynomial convergence depends on the network size, and a larger exponential regime can be accomplished with a sufficiently large network.

Next, we learn an implicit operator in the form of a nonlinear diffusion-reaction PDE with a source term u(x) described by

$$\begin{matrix}\begin{matrix}Problem 4 & \frac{\partial \text{?}}{\partial t}\end{matrix} = D \frac{\partial \text{?}}{\partial {x}^{2}} + {ks}^{2} + u ( x ) , & x ∈ ( 0 , 1 ) , \text{?}\end{matrix} ∈ ( 0 , 1 \text{?} ,$$

$$\text{?} \text{indicates text missing or illegible when filed}$$

with zero initial/boundary conditions, where D=0.01 is the diffusion coefficient, and k=0.01 is the reaction rate. We use DeepONets to learn the operator mapping from u(x) to the PDE solution s(x, t). In the previous examples, for each input u, we only use one random point of s(x) for training, and instead we may also use multiple points of s(x). To generate the training dataset, we solve the diffusion-reaction system using a second-order implicit finite difference method on a 100 by 100 grid, and then for each s we randomly select P points out of these 10000 (=100×100) grid points (FIG. 14). Hence, the dataset size is equal to the product of P by the number of u samples. We confirm that the training and test datasets do not include the data from the same s.

We investigate the error tendency with respect to the number of u samples and the value of P. When we use 100 random u samples, the test error decreases first as P increases (FIG. 4A), and then saturates due to other factors, such as the finite number of u samples and fixed neural network size. We observe a similar error tendency but with less saturation as the number of u samples increases with P fixed (FIG. 4B). In addition, in this PDE problem the DeepONet is able to learn from a small dataset, e.g., a DeepONet can reach the test error of ˜10⁻⁵ when it is only trained with 100 u samples (P=1000). We recall that we test on 10000 grid points, and thus on average each location point only has 100×1000/10000=10 training data points. For comparison, we train ResNets of different sizes with the same setup, and the test error is of ˜10⁻¹ due to large generalization error.

Next, we demonstrate that we can learn high-dimensional operators, so here we consider a stochastic ODE and a stochastic PDE and present our main findings.

Before the error saturates, the rates of convergence with respect to both P and the number of u samples obey a polynomial law in most of the range (FIGS. 4C and D). The rate of convergence versus P depends on the number of u samples, and more u samples induce faster convergence until saturation. Similarly, the rate of convergence versus the number of u samples depends on the value of P. In addition, in the initial range of the convergence, we observe an exponential convergence. The coefficient 1/k in the exponential convergence e x^{k} also depends on the number of u samples or the value of P. It is reasonable that the convergence rate increases with the number of u samples or the value of P, because the total number of training data points is equal to P×#u. However, by fitting the points, it is surprising that there is a clear tendency in the form of either ln(x) or e^{-x}, which we cannot fully explain yet, and hence more theoretical and computational investigations are required.

Consider the population growth model

$$\begin{matrix}\begin{matrix}Problem 5 & dy ( t ; ω\end{matrix} ) k ( t ; ω ) y ( t ; ω ) dt , & \text{?}\end{matrix} ∈ ( 0 , 1 ] and ω ∈ Ω , \qquad ( 5 )$$

$$\text{?} \text{indicates text missing or illegible when filed}$$

with y(0)=1. Here Ω is the random space. The randomness comes from the coefficient k(t; ω); here, k(t; ω) is modeled as a Gaussian random process such that

k(t,ω)˜ [symbol] (k₀(t),Cov(t₁,t₂)),
where the mean k₀(t)=0 and the covariance function is Cov(t₁, t₂)=σ² exp(−|t₁−t₂|²/2l²). We choose σ=1, and the correlation length l is in the range [1, 2].

We use DeepONet to learn the operator mapping from k(t; ω) of different correlation lengths to the solution y(t; ω). We note that we do not assume we know the covariance function for training DeepONet. The main differences between this example and the previous examples are that 1) here the input of the branch net is a random process instead of a function, 2) the input of the trunk net contains both physical spaces and random spaces. Specifically, to handle the random process as the input, we employ the Karhunen-Loeve (KL) expansion,

$$k ( t ; ω ) \approx {\sum }_{i = 1}^{N} \sqrt{{λ}_{i}} {e}_{i} ( t ) {ξ}_{1} ( \text{?} ) ,$$

$$\text{?} \text{indicates text missing or illegible when filed}$$

where N is the number of retained modes, λᵢ and eᵢ(t) are the i-th largest eigenvalue and its associated normalized eigenfunction of the covariance function, respectively, and ξ₁, . . . , ξ_{N} are independent standard Gaussian random variables. Then the input of the branch net is the N eigenfunctions scaled by the eigenvalues

[\sqrt{λ₁e₁(t)},\sqrt{λ₂e₂(t)}, . . . ,\sqrt{λ_{N}e_{N}(t)}]∈ [symbol] N×m
where √λᵢ eᵢ (t)=√λᵢ [(eᵢ (t₁), eᵢ(t₂)), . . . , eᵢ (tₘ)]∈R^{m}, and the input of the trunk net is [t, ξ₁, ξ₂, . . . , ξ_{N}]∈R^{N+1}.

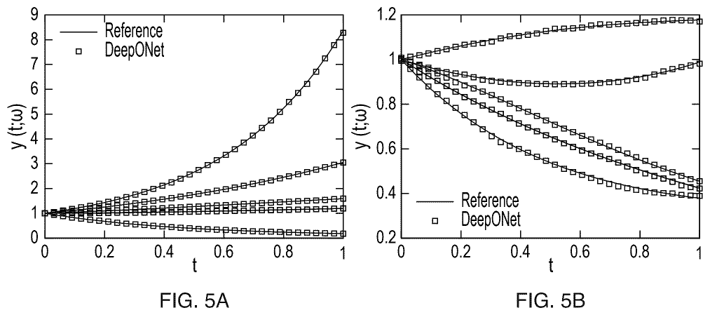

We choose N=5, which is sufficient to conserve 99.9% stochastic energy. We train a DeepONet with a dataset of 10000 different k(t; ω) with l randomly sampled in [1, 2], and for each k(t; ω) we use only one realization. The test MSE is 8.0×10⁻⁵±3.4×10⁻⁵, and as an example the prediction for 10 different random samples from k(t; ω) with 1=1.5 is in FIG. 5.

Next, we consider the following elliptic problem with multiplicative noise

$$\begin{matrix}\begin{matrix}Problem 6 & - div ( {e}^{b ( x ; ω )}\end{matrix} ∇ u ( x ; ω ) ) = \text{?} ( x ) , & x ∈\end{matrix} ( 0 , 1 ) and ω ∈ Ω ,$$

$$\text{?} \text{indicates text missing or illegible when filed}$$

with Dirichlet boundary conditions u(0)=u(1)=0. The randomness comes from the diffusion coefficient e^{b(x;ω)}, and b(x; ω)˜2 GP(b₀(x), Cov(x₁, x₂)), where the mean b₀(x)=0 and the covariance function is Cov(x₁, x₂)=σ exp(−|x₁−x₂|²/2l²). In this example, we choose a constant forcing term f (x)=10, and we set the standard deviation σ=0.1 and correlation length in the range.

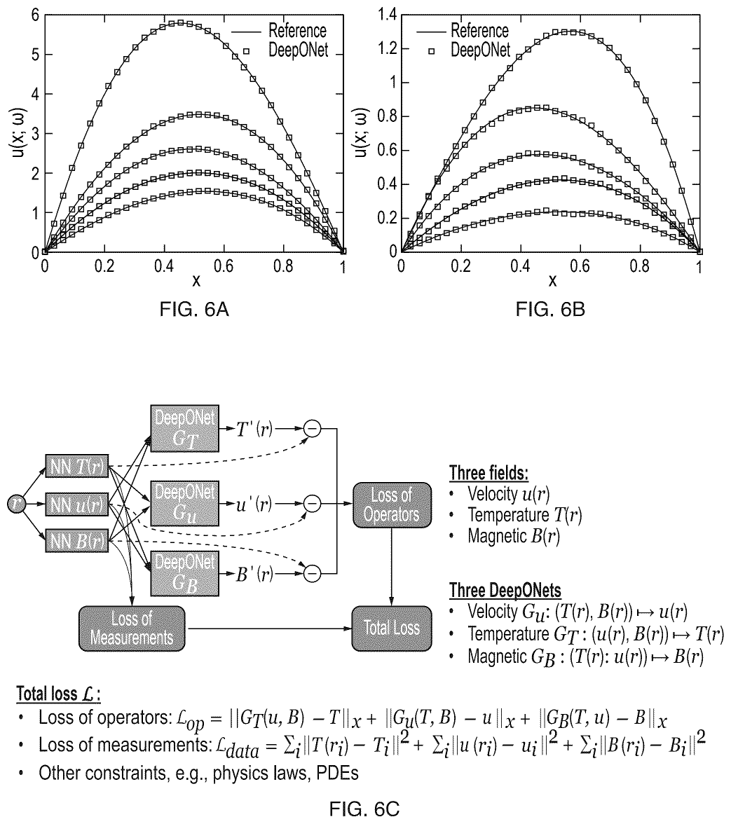

We use DeepONet to learn the operator mapping from b(x; ω) of different correlation lengths to the solution u(x; ω). We train a DeepONet with a dataset of 10000 different b(x; ω) with l randomly sampled, and for each b(x, ω) we use only one realization. The test MSE is 2.0×10⁻³±1.7×10⁻³, and as an example the prediction for 10 different random samples from b(x; ω) with 1=1.5 is in FIG. 6. We have a relative larger error in this stochastic elliptic problem, and to reduce the error further, we can remove outliers of the random variables {ξ₁, ξ₂, . . . , ξ_{N}} by clipping them to a bounded domain. For instance, if the random variables are clipped to [−3.1, 3.1], which is sufficient large to keep 99% probability space, then the test MSE is reduced to 9.4×10⁻⁴±3.0×10⁻⁴.

In summary, in DeepONets, we first construct two sub-networks to encode input functions and location variables separately, and then merge them together to compute the output.

DeepONet may be used for a number of applications, such as, for example, the following.

Multiple DeepONets can be configured together to represent one of a plurality of multiphysics problems. An example of multiple DeepONets is shown in FIG. 6C. In one example of how to utilize the multiple DeepONets, in a first step, learn each physics (i.e., the three DeepONets) separately, and in a second step minimize to couple three fields and math the measurements and other constraints.

One of the plurality of multiphysics problems includes forecasting, the forecasting comprising predicting a time and a space of a state of a system. One of the plurality of multiphysics problems includes interrogating a system with different input scenarios to optimize design parameters of the system. One of the plurality of multiphysics problems includes actuating a system to achieve efficiency/autonomy.

One of the plurality of multiphysics problems includes identifying system parameters and discovering unobserved dynamics.

The following supplemental information is helpful in understanding the present invention.

### S1 Neural Networks to Approximate Nonlinear Operators

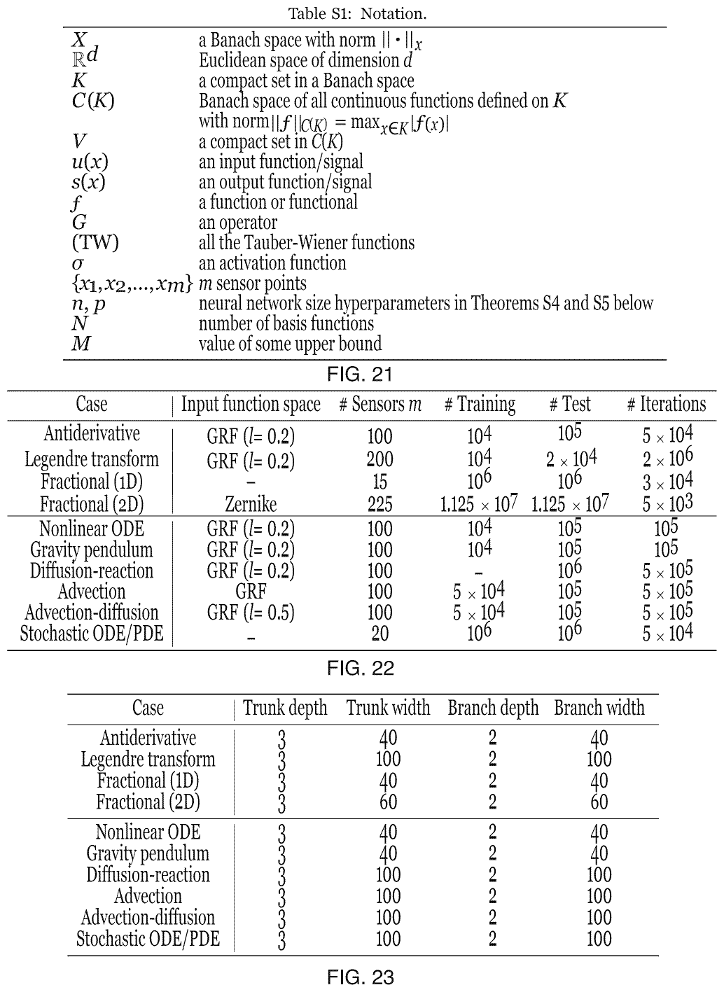

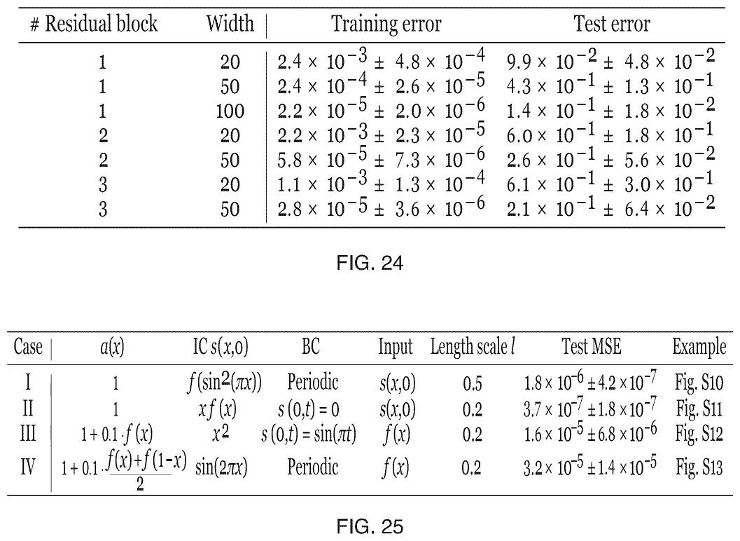

We list in the Table in FIG. 21 the main symbols and notations that are used throughout this paper.

Let C(K) denote the Banach space of all continuous functions defined on a compact set K⊂X with sup-norm ∥f∥_{C(K)}=max_{x∈K} |f (x)|, where X is a Banach space. We first review the definition and sufficient condition of Tauber-Wiener (TW) functions, and the definition of continuous operator.

Definition S1 (TW). If a function σ:R→R (continuous or discontinuous) satisfies that all the linear combinations Σ^{N}i=1 cᵢσ(λᵢx+θᵢ), λᵢ∈R, θᵢ∈R, cᵢ∈R, i=1, 2, . . . , N, are dense in every C([a, b]), then σ is called a Tauber-Wiener (TW) function.

Theorem S2 (Sufficient condition for TW). Suppose that σ is a continuous function, and σ∈S′(R) (tempered distributions), then σ∈(TW), if and only if σ is not a polynomial.

It is easy to verify that all the activation functions we used nowadays, such as sigmoid, tanh and ReLU, are TW functions.

Definition S3 (Continuity). Let G be an operator between topological spaces X and Y. We call G continuous if for every ϵ>0, there exists a constant δ>0 such that

$${‖ G ( x ) - G ( y ) ‖}_{Y} < ϵ$$

for all x, y∈X satisfying ∥x−y∥_{X}<δ.

We recall the following two main theorems of approximating nonlinear continuous functionals and operators.

Theorem S4 (Universal Approximation Theorem for Functional). Suppose that σ∈(TW), X is a Banach Space, K⊂X is a compact set, V is a compact set in C(K), f is a continuous functional defined on V, then for any ϵ>0, there are a positive integer n, m points x₁, . . . , xₘ∈K, and real constants cᵢ, θᵢ, ξᵢⱼ, i=1, . . . , n, j=1, . . . , m, such that

$$\vert f ( u ) - \sum \text{?} ( {\sum }_{j = 1}^{m} {ξ}_{ij} u ( {x}_{j} ) + {θ}_{i} ) \vert < \text{?}$$

$$\text{?} \text{indicates text missing or illegible when filed}$$

holds for all u∈V.

Theorem S5 (Universal Approximation Theorem for Operator). Suppose that σ∈(TW), X is a Banach Space, K₁⊂X, K₂⊂R^{d} are two compact sets in X and R^{d}, respectively, V is a compact set in C(K₁), G is a nonlinear continuous operator, which maps V into C(K₂), then for any ϵ>0, there are positive integers n, p, m, constants c^{k}ᵢ; ξᵢⱼ^{k}, θᵢ^{k}, ζₖ∈R, wₖ∈R^{d}, xⱼ∈K₁, i=1, . . . , n, k=1, . . . , p, j=1, . . . , m, such that

$$\vert G ( u ) ( y ) - {\sum }_{k = 1}^{p} {\sum }_{i = 1}^{n} {c}_{i}^{k} \text{?} ( {\sum }_{j = 1}^{m} {ξ}_{ij}^{k} u ( {x}_{j} ) + {θ}_{i}^{k} ) \text{?} ( {w}_{k} \cdot y + {ζ}_{k} ) \vert < \text{?}$$

$$\text{?} \text{indicates text missing or illegible when filed}$$

holds for all u∈V and y∈K₂.

The necessary and sufficient conditions of the compactness are given by the following Arzelà-Ascoli Theorem.

Definition S6 (Uniform Boundedness). Let V be a family of real-valued functions on the set K. We call V uniformly bounded if there exists a constant M such that

|f(x)|≤M
for all f∈V and all x∈K.

Definition S7 (Equicontinuity). Let V be a family of real-valued functions on the set K. We call V equicontinuous if for every ϵ>0, there exists a δ>0 such that

$$\vert f ( x ) - f ( y ) \vert < ϵ$$

for all f∈V and all x, y∈K satisfying |x−y|<δ.

Theorem S8 (Arzelà-Ascoli Theorem). Let X be a Banach space, and K⊂X be a compact set. A subset V of C(K) is pre-compact (has compact closure) if and only if V is uniformly bounded and equicontinuous.

### S2 Data Generation

Here, we list the details of function spaces V and reference solutions.

Gaussian random fields (GRFs). In most examples, we use the mean-zero GRFs for the input function u(x):

u(x)˜GP(0,k₁(x₁,x₂)),
where the covariance kernel k₁(x₁, x₂)=exp(−∥x₁−x₂∥²/2l²) is the Gaussian kernel with a length-scale parameter 1>0. The length-scale l determines the smoothness of the sampled function, and larger l leads to smoother u.

Orthogonal polynomials. Let M>0 and Pi be i-th orthogonal polynomial basis. We define the N-dimensional orthogonal polynomial space as

$${V}_{Org} = \{ {\sum }_{i = 0}^{N - 1} \text{?} {P}_{i} ( x ) : \vert \text{?} \vert \leq M \} .$$

$$\text{?} \text{indicates text missing or illegible when filed}$$

We generate the samples of input function u(⋅) from the space V_{Org} by randomly sampling the expansion coefficient aᵢ from [−M, M].

Here, we consider four different bases Pᵢ(⋅):
1. the Chebyshev polynomial of the first kind Tᵢ(x);
2. the Legendre polynomial Lᵢ(x);
3. the poly-fractonomial polynomial (1+x)^{0.5}Jᵢ^{-0.5,0.5}(x);
4. the Zernike polynomial Zᵢ(r, θ), where Zᵢ(r, θ) is the single indexing Zernike polynomial whose index i is linked to the indices of double-indexing one Z^{m}ₙ (r,θ) by i=(n(n+2)+m)/2.

Reference solutions. The reference solutions of all ODE systems are obtained by Runge-Kutta, and the reference solutions of all deterministic PDEs are obtained by a second-order finite difference method.

The exact solution of the stochastic ODE is

y=y₀e^{K(t)},
where K(t)=∫^{t}₀ k(s)ds is again Gaussian process with mean zero.

The exact solution of the stochastic PDE is

$$u ( x ) = C ( ω ) \int \text{?} dy \int \text{?} \int \text{?} f ( \text{?} ) d \text{?} dy ,$$

$$where$$

$$C ( ω ) = {( \int \text{?} dy )}^{- 1} \int \text{?} \int \text{?} f ( z ) dz dy .$$

$$\text{?} \text{indicates text missing or illegible when filed}$$

Numerical solutions are obtained by approximating k(t; ω) or b(x; ω) with their truncated Karhunen-Loeve expansions.

S3 Gaussian Random Field with the Gaussian Kernel

Suppose that X(t)˜GP(0, exp(−|x−y|²)). Then, by the Wiener-Khinchin Theorem, we have

$$X ( t ) \sqrt{2} ( π ) \text{?} ( \text{?} ) \text{?} cos ( ω t ) exp ( 0 - \frac{\text{?} {ω}^{2}}{8} ) dW ( ω ) - \sqrt{2} ( π ) \text{?} \int \text{?} ( \text{?} ) sin ( ω t ) exp ( \frac{\text{?} {ω}^{2}}{8} ) dB ( ω ) \text{?}$$

$$\text{?} \text{indicates text missing or illegible when filed}$$

where W and B are independent standard Brownian motions. Apply the change of variable λ=1ω and write X(t) as

$$X ( t ) = \sqrt{2} ( π ) \text{?} \int \text{?} cos ( \frac{λ}{l} t ) exp ( - \frac{{λ}^{2}}{8} ) dW ( λ ) - \sqrt{2} ( π ) \text{?} \int \text{?} sin ( \frac{λ}{l} t ) exp ( - \frac{{λ}^{2}}{8} ) dB ( λ ) .$$

$$\text{?} \text{indicates text missing or illegible when filed}$$

Applying a linear interpolation Π₁ on the interval [tᵢ, tᵢ₊₁], then

$$\text{?} [ {( X ( t ) - {\prod }_{1} X ( t ) )}^{2} ] = \sqrt{2} ( π ) \text{?} \int \text{?} ( {( I - {\prod }_{1} cos ( \frac{λ}{l} t ) )}^{2} exp ( - \frac{{λ}^{2}}{4} ) d λ + \text{} 2 ( π ) \text{?} \int \text{?} ( {( I - {\prod }_{1} sin ( \frac{λ}{l} t ) )}^{2} exp ( - \frac{{λ}^{2}}{4} ) d λ \leq ( π ) \text{?} ( {t}_{i + 1} - t \text{?} ) \text{?} \int \text{?} {( \frac{λ}{l} )}^{4} exp ( \frac{{λ}^{2}}{4} ) d λ = 24 π \frac{( {t}_{i + 1} - t \text{?} ) \text{?}}{\text{?}} .$$

$$\text{?} \text{indicates text missing or illegible when filed}$$

where we recalled the error estimate of the linear interpolation on [a, b] (by Taylor's expansion)

$$\vert ( I - {\prod }_{1} ) g ( t ) \vert = \frac{1}{2} {( b - a )}^{2} \vert g \text{?} ( ξ ) \vert \text{?}$$

$$\text{?} \text{indicates text missing or illegible when filed}$$

where lies in between a and b. Then by the fact that X(t)−Π₁X(t) is Gaussian, we have

$$\vert X ( t ) - {\prod }_{1} X ( t ) \vert \leq C \frac{{( {t}_{i + 1} - t \text{?} )}^{2}}{{I}^{2}} , \text{?} > 0 , t ∈ [ t \text{?} , {t}_{i + 1} ] \text{?}$$

$$\text{?} \text{indicates text missing or illegible when filed}$$

where C is an absolute value of a Gaussian random variable with mean zero and variance (24π)^{0.5}.

### S4 Number of Sensors for Identifying Nonlinear Dynamical Systems

This part is the proof of Theorem 2. All the concepts and notations involved here are defined in the paragraph of Theorem 2.

Lemma. W:=∪^{∞}ᵢ₌₁ Wᵢ is compact.

Proof. At first, we prove that W is pre-compact. For any ε>0, by (3), there exists an m₀ such that

$$‖ u - \text{?} ( \text{?} ) ‖ \text{?} < \frac{ε}{4} \text{?} \qquad ∀ u ∈ V , ∀ m > m \text{?}$$

$$\text{?} \text{indicates text missing or illegible when filed}$$

Since Wₘ_{₀} is a compact set subject to equicontinuity, there exists a δ>0 such that

$$\begin{matrix}\vert x - y \vert < δ ⇒ \vert u ( x ) - u ( y ) \vert < \frac{ε}{2} \text{?} & ∀ u ∈\end{matrix} {W}_{{m}_{0}} \text{?} ∀ x , y ∈ [ a , b ] .$$

$$\text{?} \text{indicates text missing or illegible when filed}$$

Now for all u∈W and all x, y∈[a, b], |x−y|<δ, if u∈Wₘ_{₀}, naturally we have |u(x)−u(y)|<ε/2<ε, otherwise, u∈U^{∞}ᵢ₋ₘ_{₀}₊₁ Uᵢ. Suppose that u=Lₘ(v), m>m₀, v∈V, then there holds

$$\vert u ( x ) - u ( y ) \vert = \vert u ( x ) - \text{?} ( x ) + \text{?} ( x ) - v ( y ) + \text{?} ( y ) - u ( y ) \vert \leq \vert \text{?} ( \text{?} ) ( x ) - v ( x ) \vert + \vert \text{?} ( x ) - v ( y ) \vert + \vert \text{?} ( \text{?} ) ( y ) - v ( y ) \vert \leq 2 ‖ \text{?} ( v ) - v ‖ \text{?} + \vert v ( x ) - v ( y ) \vert < 2 \cdot \frac{ε}{4} + \frac{ε}{2} = ε ,$$

$$\text{?} \text{indicates text missing or illegible when filed}$$

Which shows the equicontinuity of W. In addition, it is obvious that W is uniformly bounded, so that we know W is pre-compact by applying the Arzelà-Ascoli Theorem.

Next we show that W is closed. Let {wᵢ}^{∞}ᵢ₌₁⊂W be a sequence which converges to a w₀∈C[a, b]. If there exists an m such that {wᵢ}⊂Wₘ, then w₀∈Wₘ⊂W. Otherwise, there is a subsequence {Lᵢ_{ₙ} (vᵢ_{ₙ})} of {wᵢ} such that vᵢ_{ₙ}∈V and iₙ→∞ as n→∞. Then we have

$${‖ \text{?} - \text{?} {‖}_{C} = \text{?} - \text{?} ( \text{?} ) + \text{?} ( {v}_{{i}_{n}} ) - {w}_{0} ‖}_{C} \leq ‖ \text{?} - \text{?} ( \text{?} ) ‖ \text{?} + {‖ \text{?} ( {v}_{{i}_{n}} ) - {w}_{0} ‖}_{C} \leq \text{?} ( \text{?} V ) + {‖ \text{?} ( \text{?} ) - {w}_{0} ‖}_{C} ,$$

$$\text{?} \text{indicates text missing or illegible when filed}$$

which implies that w₀=limₙ→∞ vᵢ_{ₙ}∈V⊂W.

Next we show the proof of Theorem 2.

Proof. For u∈V and uₘ∈Uₘ, according to the bound (3) and the Lipschitz conditions of the right-hand side of the ODE, we can derive that the operator is Lipschitz continuous.

$${‖ G ( u ) ( d ) - G ( {u}_{m} ) ( d ) ‖}_{2} \leq c {\int }_{a}^{d} {‖ G ( u ) ( t ) - G ( {u}_{m} ) ( t ) ‖}_{2} dt + c {\int }_{a}^{d} \vert u ( t ) - {u}_{m} ( t ) \vert dt \leq c {\int }_{a}^{d} {‖ G ( u ) ( t ) - G ( {u}_{m} ) ( t ) ‖}_{2} dt + c ( b - a ) \text{?} ( m , V ) .$$

$$\text{?} \text{indicates text missing or illegible when filed}$$

Here κ(m, V) is defined in (3). By Grönwall's inequality, we have

$${‖ G ( u ) ( d ) - G ( {u}_{m} ) ( d ) ‖}_{2} \leq c ( b - a ) \text{?} ( m , V ) \text{?} .$$

$$\text{?} \text{indicates text missing or illegible when filed}$$

Define Sₘ={(u(x₀), u(x₁), . . . , u(xₘ))∈R^{m+1}|u∈V}. Then Sₘ is a compact set in R^{m+1} as it is the image of a continuous map on the compact set V. As there is a bijective map between Sₘ and Uₘ, we may define a vector-valued function ϕ on Sₘ by

$$φ ( u ( {x}_{0} ) , u ( {x}_{1} ) , … , u ( {x}_{m} ) ) = G ( {u}_{m} ) ( d ) .$$

Because G is a continuous operator over V, ϕ is a continuous function over Sₘ. For any ε>0, make m large enough so that c(b−a)κ(m, V)e^{c(b-a)}<. By the universal approximation theorem of neural network for high-dimensional functions, there exist W₁∈R^{n×(m+1)}, b₁∈R^{m+1}, W₂∈R^{K×n},b₂∈R^{K}, such that

$${‖ φ ( u ( {x}_{0} ) , … , u ( {x}_{m} ) ) - {W}_{2} \cdot σ ( {W}_{1} \cdot {[ u ( {x}_{0} ) … u ( {x}_{m} ) ]}^{T} + {b}_{1} ) + {b}_{2} ) ‖}_{2} < \text{?} - c ( b - a ) \text{?} ( m , V ) \text{?}$$

$$\text{?} \text{indicates text missing or illegible when filed}$$

holds for all (u(x₀), . . . , u(xₘ))∈Sₘ. Hence, we have

$${‖ ( Gu ) ( d ) - {W}_{2} \cdot σ ( {W}_{1} \cdot {[ u ( {x}_{0} ) … u ( {x}_{m} ) ]}^{T} + {b}_{1} ) + {b}_{2} ) ‖}_{2} \leq {‖ ( Gu ) ( d ) \text{} - \\ ( {Gu}_{m} ) ( d ) ‖}_{2} + {‖ ( {Gu}_{m} ) ( d ) - ( {W}_{2} \cdot σ ( {W}_{1} \cdot {[ u ( {x}_{0} ) … u ( {x}_{m} ) ]}^{T} + {b}_{1} ) + {b}_{2} ) ‖}_{2} < c ( b - a ) \text{?} ( m , V ) \text{?} + \text{?} - c ( b - a ) \text{?} ( m , V ) \text{?} = ε .$$

$$\text{?} \text{indicates text missing or illegible when filed}$$

In summary, by choosing the value of m so that it makes c(b−a)κ(m, V)e^{c(b-a)} less than ε is sufficient to achieve accuracy ε.

### Wasserstein Metric for Gaussian Processes

Different metrics have been proposed to measure the distance between two Gaussian processes, and we will use the 2-Wasserstein metric in this study. Suppose we have two GPs f₁ GP(m₁; k₁) and f₂ GP(m₂; k₂) defined on X, where m₁ and m₂ are the mean functions, and k₁ and k₂ are the covariance functions. Each covariance function kᵢ has an associated covariance operator Kᵢ:L²(X)−+L²(X) defined by

$$\begin{matrix}[ {K}_{i} ] ( x ) = \int \text{?} ( {k}_{i} ( x , s ) ( s ) ds , & ∀\end{matrix} ∈ {L}^{2} ( X ) .$$

$$\text{?} \text{indicates text missing or illegible when filed}$$

Then the 2-Wasserstein metric between the two Gaussian processes f₁ and f₂ is given by

$${W}_{2} ( {f}_{1} , {f}_{2} ) := {\{ {‖ {m}_{1} - {m}_{2} ‖}_{2}^{2} + Tr [ {K}_{1} + {K}_{2} - 2 {K}_{1}^{\frac{1}{2}} {K}_{2} {{K}_{1}^{\frac{1}{3}}}^{\frac{1}{2}} ] \}}^{\frac{1}{2}} \text{?}$$

$$\text{?} \text{indicates text missing or illegible when filed}$$

where Tr is the trace of the operator.

In practice, we may not be able to compute the 2-Wasserstein metric analytically. To estimate it numerically, we can estimate the trace of the operator from the trace of the corresponding covariance matrix. For example, let \hat{ }K1∈R^{N N} be a covariance matrix of k₁, i.e., the i^{th}-row and j^{th}-column entry of \hat{ }K₁ is \hat{ }K₁[i; j]=k₁ (xᵢ; xⱼ), where {x₁; x₂; : : : ; x_{N}} are N equispaced points in the domain of f₁. Then we have TrK₁ Tr \hat{ }K₁/N, and we can estimate other traces in the same way.

### S5 Parameters

In all problems we use ReLU activation function, except that for fractional differential operators we use the hyperbolic tangent. We use the Adam optimizer with learning rate 0.001, except that for the Legendre transform it is 0.0001. The other parameters and network sizes are listed in Tables found in FIGS. 22 and 23.

Computational Cost (Hours) of Training of deepONet and NN Baselines.

DeepONet size is listed in the below Table, and the network sizes of other models are chosen as the sizes with which the best accuracy is obtained. All networks are trained using 4 cores on an Intel Xeon Gold 6242 processor.

| Case | DeepONet | FNN | ResNet | [symbol] NN | Seq2Seq |
|---|---|---|---|---|---|
| Antiderivative | 0.10 | 1.39 | 0.07 | — | 0.77 |
| Legend [symbol] transform | 10. [symbol] 3 | — | — | — | — |
| Fractional (1D) | 14.24 | — | — | — | — |
| Fractional (2D) | 7 [symbol] .41 | — | — | 2.28 | — |
| Nonlinear ODE | 0.27 | — | — | — | — |
| Gravity pendulum | 0.19 | 0.31 | — | — | 1.71 |
| D [symbol] usion-reaction | 12.25 | — | 3. [symbol] 9 | — | — |
| Advection (4 cases) | 11. [symbol] 6 | — | — | — | — |
| Advection [symbol] di usion | 14.51 | — | — | — | — |
| Stochastic ODE/PDE | 27. [symbol] 3 | — | — | — | — |
| (pathwise) | | | | | |
| Stochastic PDE | 0.13 | — | — | — | — |
| (mean/SD) | | | | | |

[symbol]

indicates data missing or illegible when filed

### Computational Cost (Seconds) of Running Inference of DeepONet, NN Baselines and Numerical Solvers.

DeepONet size is listed in the below Table, and the network sizes of other models are chosen as the sizes with which the best accuracy is obtained. The numerical solvers used for each case are described. The network inferences and numerical solvers are performed using 1 core on an Intel Xeon Gold 6242 processor.

| Case | DeepONet | | FNN | | ResNet | | CNN | Seq2Seq | | Numerical solver | |
|---|---|---|---|---|---|---|---|---|---|---|---|
| Antiderivative | 1.3 | 10⁻⁴ | [symbol] .9 | 10⁻⁴ | 3.5 | 10⁻⁴ | — | 1.4 | 10⁻² | 8.0 | 10⁻⁴ |

| | | | | | | | | |
|---|---|---|---|---|---|---|---|---|
| Legendre transform | 1.4 | 10⁻⁴ | — | — | — | — | 1.2 | 10⁻⁵ |

| Fractional (1D) | 1. [symbol] | 10⁻⁴ | — | — | — | | — | 117. [symbol] |
|---|---|---|---|---|---|---|---|---|
| Fractional (2D) | [symbol] .2 | 10⁻⁴ | — | — | 3.5 | 10⁻⁴ | — | 4 [symbol] . [symbol] |

| Nonlinear ODE | 1.3 | 10⁻⁴ | — | | — | — | — | | 9.5 | 10⁻⁴ |
|---|---|---|---|---|---|---|---|---|---|---|
| Gravity pendulum | 1.3 | 10⁻⁴ | 3. [symbol] | 10⁻⁴ | — | — | 1.3 | 10⁻² | 1.4 | 10⁻ [symbol] |

| | | | | | | | | | |
|---|---|---|---|---|---|---|---|---|---|
| Di usion-reaction | 3.7 | 10⁻⁴ | — | [symbol] .6 | 10⁻³ | — | — | 1.9 | 10⁻² |

| | | | | | | | | |
|---|---|---|---|---|---|---|---|---|
| Advection (4 cases) | 3.7 | 10⁻⁴ | — | — | — | — | 9.0 | 10⁻ [symbol] |
| Advection-di usion | 3.7 | 10⁻ [symbol] | — | — | — | — | 9.0 | 10⁻ [symbol] |

| | | | | | | | |
|---|---|---|---|---|---|---|---|
| Stochastic ODE/PDE (pathwise) | [symbol] | 10⁻ [symbol] | — | — | — | — | Analytical solution |
| Stochastic PDE (mean/SD) | [symbol] | 10⁻ [symbol] | — | — | — | — | Analytical solution |

[symbol]

indicates data missing or illegible when filed

### S6 Legendre Transform

We consider the Legendre transform of a function f (x):

$$\begin{matrix}Problem 7 & \\ {𝒥}_{n} ( f ( x ) ) = {\int }_{- 1} {P}_{n} ( x ) f ( x ) dx , & ( S6 )\end{matrix}$$

where Pₙ(x) is a Legendre polynomial of degree n. We use DeepONet to learn the Legendre transform f (x)→Jₙ{f (x)}. Because the Legendre transform decays fast to zero w.r.t. n for a smooth f (x), it is sufficient to consider the first 20 coefficients, i.e., n∈{0, 1, 2, . . . , 19}. To generate the dataset, we sampled 500 random f (x) from a GRF with the Gaussian kernel of the length scale 1=0.2, and computed the Legendre transform at the first 20 coefficients for each f (x). Thus the dataset size is equal to 10000(=500×20). The test MSE is 3.2×10⁻⁷±1.9×10⁻⁷, and two prediction examples are shown in FIG. 22.

### S7 Nonlinear ODE System

We consider a nonlinear 1D ODE system

$$Problem 1. C$$

$$\frac{ds ( x )}{dx} = g ( s ( x ) , u ( x ) , x ) , x ϵ ( 0 , 1 ) , where g ( s ( x ) , u ( x ) , x ) = - {s}^{2} ( x ) + u ( x ) .$$

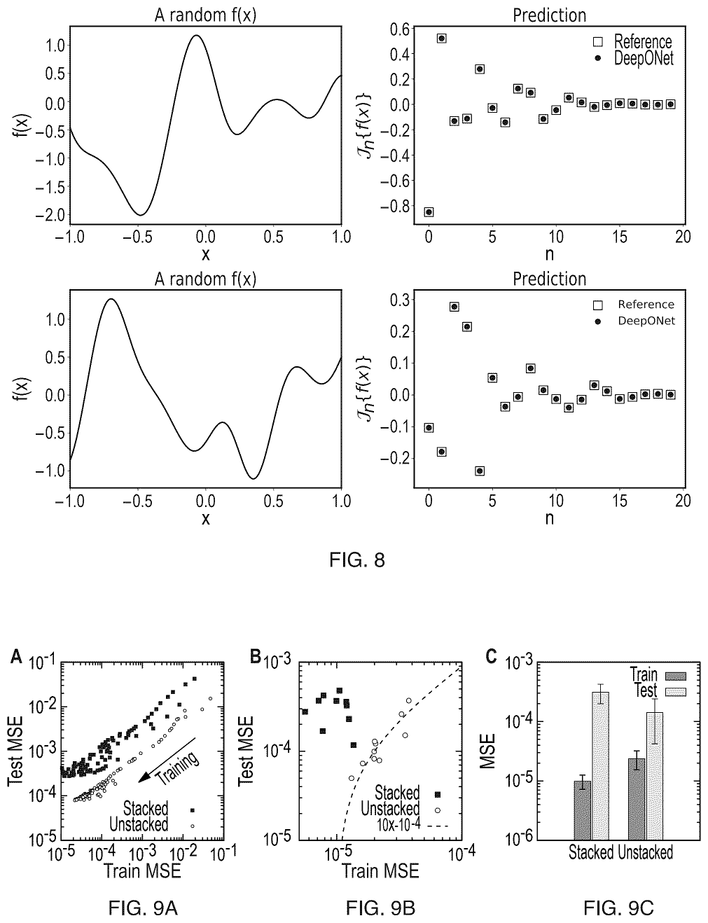

with an initial condition s(0)=0. Because s(x) may explode for certain u, we compute the test MSE by removing the 1‰ worst predictions. During the network training, the training MSE and test MSE of both stacked and unstacked DeepONets decrease, but the correlation between training MSE and test MSE of unstacked DeepONets is tighter, i.e., smaller generalization error. This tight correlation between training and test MSE of unstacked DeepONets is also observed across multiple runs with random training dataset and network initialization (FIG. 8B). Moreover, the test MSE and training MSE of unstacked DeepONets follow almost a linear correlation

$$M S {E}_{t e s t} = 10 \times M S {E}_{train} - 1 {0}^{- 4} .$$

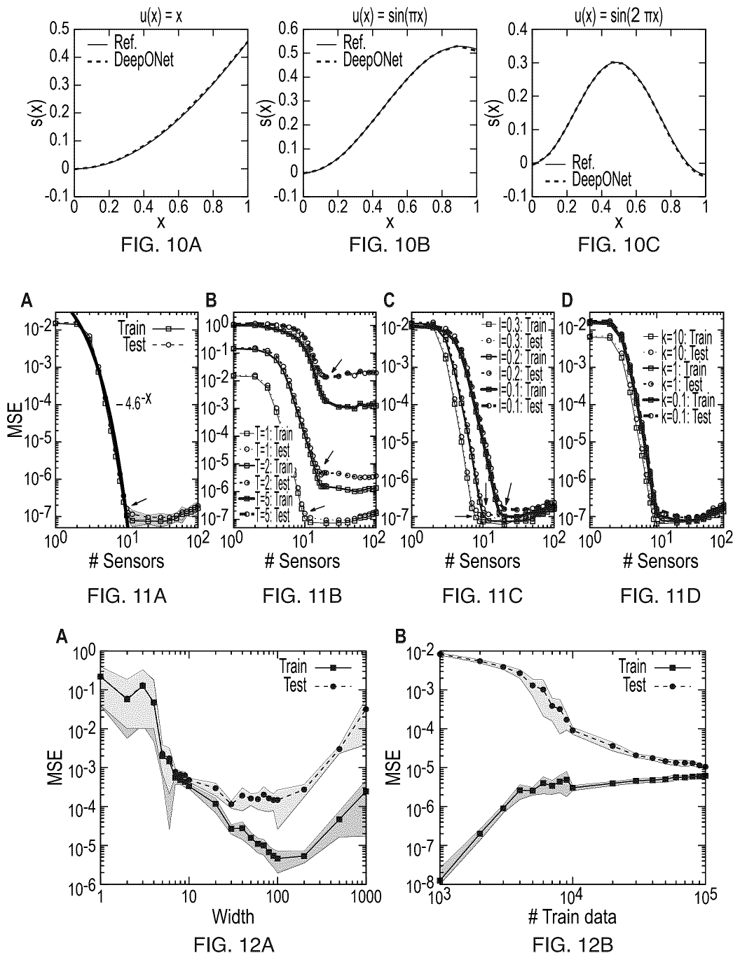

FIG. 8C shows that unstacked DeepONets have smaller test MSE due to smaller generalization error. DeepONets work even for out-of-distribution predictions, see three examples of the prediction in FIG. 10.

S8 Gravity Pendulum with an External Force

### S8.1 Number of Sensors

The number of sensors required to distinguish two input functions depends on the value of k, prediction time T, and the input function space. For the case with the default parameters k=1, T=1 and 1=0.2, when the number of sensors m is small, the error decays exponentially as we increase the number of sensors (FIG. 11A):

MSE∝4.6^{-#sensors}.

When m is already large, the effect of increasing m is negligible. The transition occurs at ˜10 sensors, as indicated by the arrow.

To predict s for a longer time, more sensors are required (FIG. 11B). For example, predicting until T=5 requires ˜25 sensors. If the function u is less smooth corresponding to smaller l, it also requires more sensors (FIG. 11C). However, the number of sensors is not sensitive to k (FIG. 11D). Although it is hard to quantify the exact dependency of m on T and l, by fitting the computational results we show that

$$m ∝ \sqrt{T} and m ∝ {1}^{- 1} .$$

In Theorem 2, m should be large enough to make T e^{cT} κ(m, V) small. In Section S3 we show theoretically that m∝l⁻¹ for the GRF function space with the RBF kernel, which is consistent with our computational result here. T e^{cT} in the bound is loose compared to the computational results.

### S8.2 Error Tendency and Convergence

Here, we investigate the error tendency under different conditions, including network size, and training dataset size. We take T=3 for the following experiments in this subsection. By varying the network width, we can observe that there is a best width to achieve the smallest error (FIG. 12A). It is reasonable that increasing the width from 1 to 100 would decrease the error, but the error would instead increase when the width further increases. This could be due to the increased optimization error, and a better learning rate may be used to find a better network. To examine the effect of training dataset size, we choose networks of width 100 to eliminate the network size effect, and the training and test errors using different dataset size are shown in FIG. 12B. The test and generalization errors of networks with width 50 and 200 are shown in FIG. 3.

### S8.3 Input Function Spaces

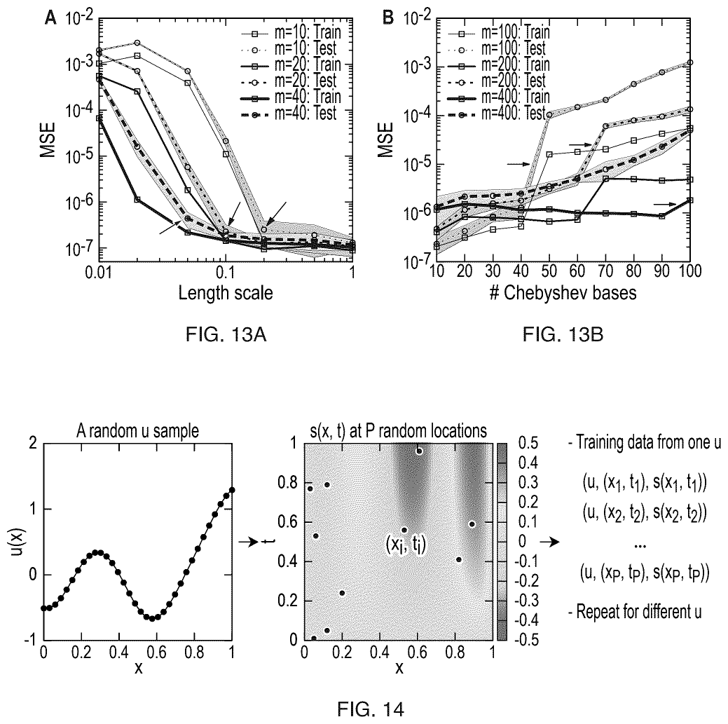

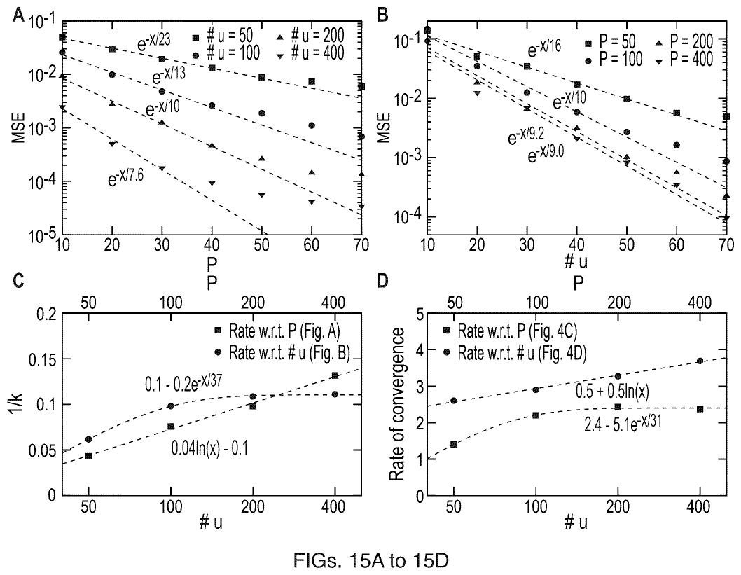

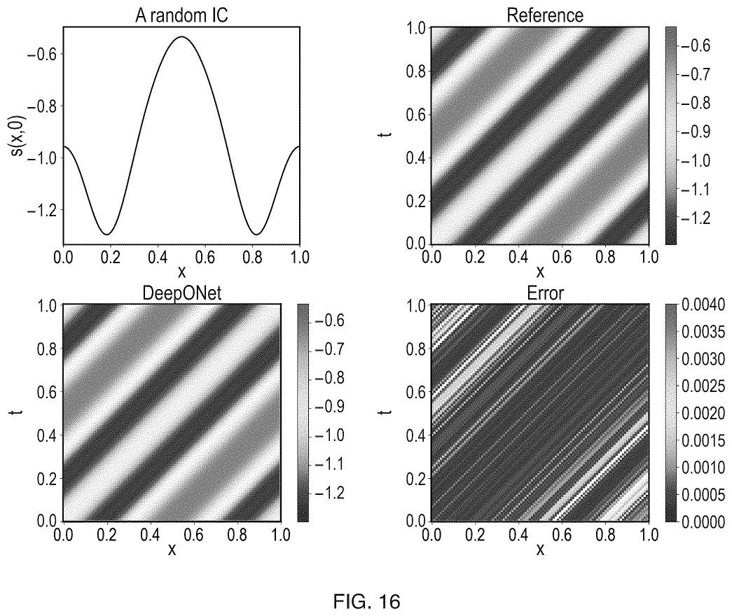

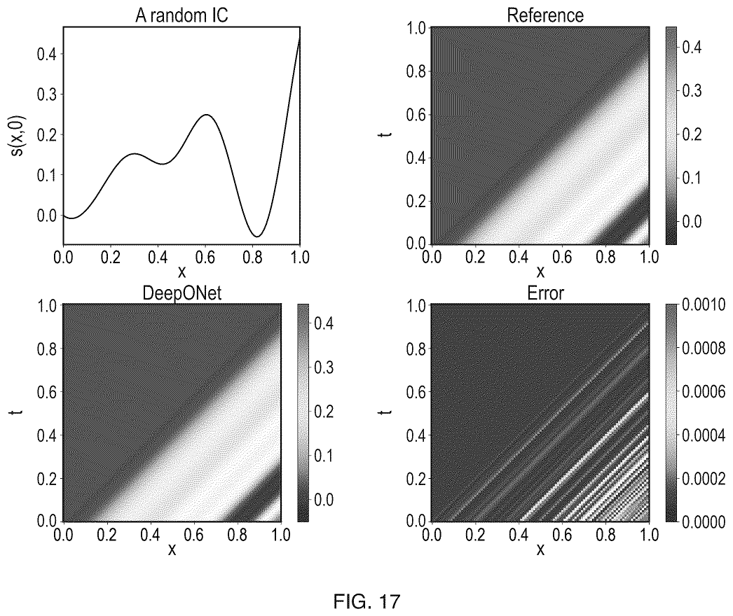

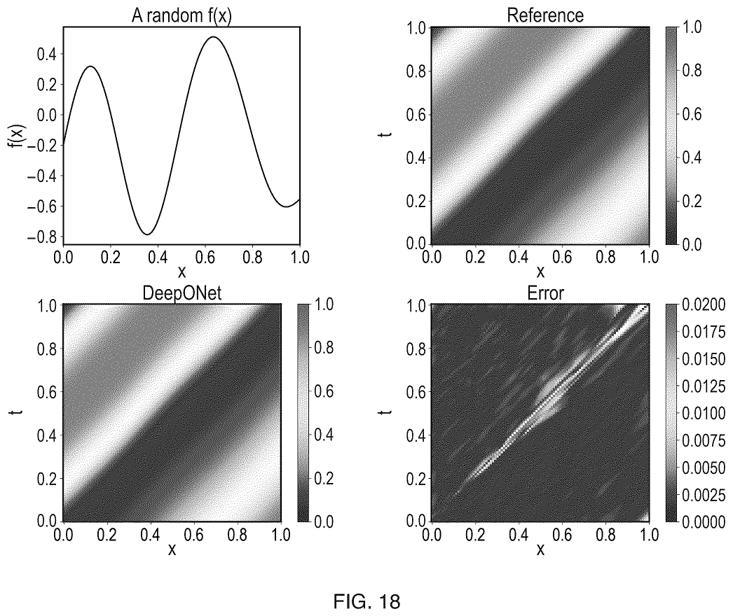

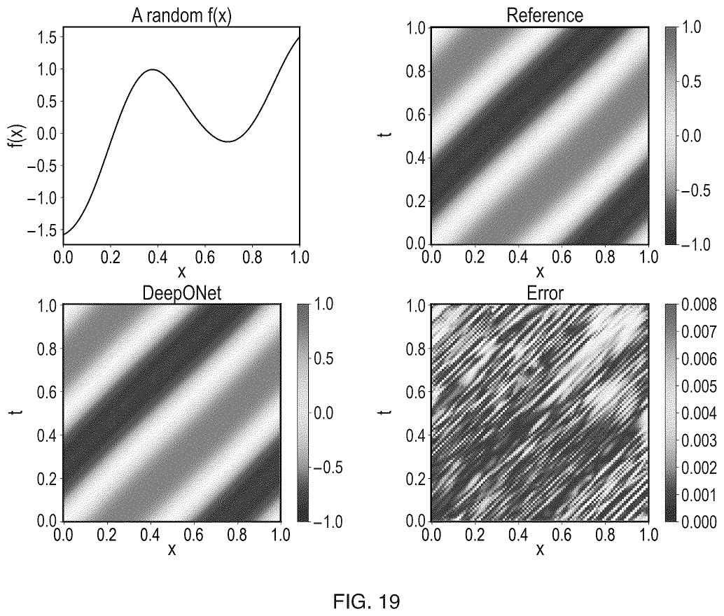

Next, we investigate the effect of different function spaces, including GRF with different length scale l and the space of Chebyshev polynomials with different number of bases. For a fixed sensor number, we observe that there exists a critical length scale, around where the training and test errors change rapidly, see the arrows in FIG. 13A. This sharp transition around the critical value is also observed in the space of Chebyshev polynomials with different number of bases (FIG. 13B). The relations between the critical values and the sensor numbers are

l∝m⁻¹ and #Bases∝√m.

The inverse relation between 1 and m is consistent with the theoretical results in Section S3 and the computational results in Section 14.1. Therefore, when the function space complexity increases, one may increase m to capture the functions well.

S9 Diffusion-Reaction System with a Source Term

FIG. 14 illustrates learning a diffusion-reaction system and Table 10 illustrates mean and standard deviation.

### S10 Advection Equation

Consider the advection equation

$$Problem 8$$

$$\frac{\partial s}{\partial t} + a ( x ) \frac{\partial s}{\partial x} = 0 , x ϵ [ 0 , 1 ] , t ϵ [ 0 , 1 ] ,$$

and here we learn four operators mapping from different input functions to the solution s(x, t). The choices of a(x), IC/BC and DeepONet input function are listed in Table S5 in FIG. 25. We note that in these four cases, a(x) is positive. In Cases I and IV we use a periodic BC, and thus the IC is also chosen to be periodic.

To generate the training dataset, we solve the system using a finite difference method on a 100 by 100 grid, except for the Case I with the analytical solution s(x, t)=f (sin²(π(x−t)). Then for each solution s(x, t) we randomly select P=100 points out of these 10000(=100×100) grid points. The dataset size is equal to the product of P by the number of input function samples. We sample f (x) from a GRF with the Gaussian kernel of different length scale l, and we use 500 random f samples for training.

### S11 Advection-Diffusion Equation

Consider the advection-diffusion equation

$$\begin{matrix}Problem 9 & \\ \frac{\partial s}{\partial t} + \frac{\partial s}{\partial x} - D \frac{{\partial }^{2} s}{\partial {x}^{2}} = 0 , x ϵ [ 0 , 1 ] , t ϵ [ 0 , 1 ] , & ( S7 )\end{matrix}$$

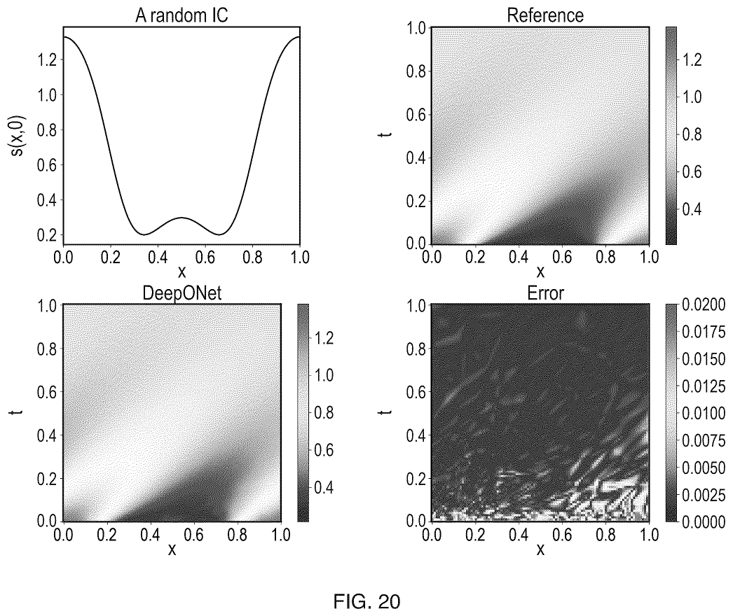

with the periodic boundary condition and initial condition s(x, 0)=f (sin²(πx)), where D=0.1 is the diffusion coefficient and f (x) is sampled from a GRF with the Gaussian kernel of the length scale 1=0.5. Here, s(x, 0) is the input function, and we use DeepONets to learn the operator mapping from s(x, 0) to the solution s(x, t). To generate the training dataset, we solve the system using a finite difference method on a 100 by 100 grid, and then for each solution s(x, t) we randomly select P=100 points out of these 10000(=100×100) grid points. The dataset size is equal to the product of P by the number of s(x, 0) samples which is set to 500 here. The test MSE is 8.7×10⁻⁶±1.1×10⁻⁶ and FIG. 20 is an example for prediction.

### S12 Fractional Differential Operators

Below we detail the data generation and NN architectures for learning the 1D Caputo fractional derivative and the 2D fractional Laplacian.

### S12.1 1D Caputo Derivative Operator

The error (mean and standard deviation) tested on the space of GRF with the correlation length l=0.1 for DeepONets trained with GRF spaces of different correlation length l. The 2-Wasserstein metric between the GRF of 1=0.1 and the GRF of different correlation length l. The test error grows exponentially with respect to the W2 metric.

The V spaces we consider are Legendre polynomial space, poly-fractonomial space, and GRF, all of which have been mentioned in Section S2. For the Legendre and poly-fractonomial spaces, we take M=2 and N=11. The expansion coefficients are taken from Sobol sequence, a quasi-random sequence. For the GRF, we set 1=0.1 and 1=0.3 in the Gaussian kernel for training and test sets, respectively.

Given the discrete version of the input function u(⋅), i.e., [u(x₁), . . . , u(xₘ)]T, the evaluation point y, and the fractional order a, the reference solution G(u)(y, α) is computed by using the L1 scheme, a finite difference scheme for approximating Caputo fractional derivative. We take 2000 finite difference points in order to ensure that the computed value of output function is sufficiently accurate.

The training set is determined by the following parameters. The number of different samples of u(⋅) is Nu=10000. The number of the equi-spaced “sensors” for u(⋅) is m=15. The numbers of different equi-spaced evaluation points y and a for the output function G(u)(y, α) are both N_{y}=N_{α}=10. The number of training points is calculated as Nᵤ×N_{y}×N_{α}=10⁶. The same parameters are taken for the test set.

### S12.2 2D Fractional Laplacian Operator

The V space, where u(r, θ) is sampled from, is an orthogonal polynomial space spanned by the Zernike polynomial Zi(r, θ), where r and θ are the radius and angle in the polar coordinate, respectively. We take 15 basis functions {Z₀, Z₁, . . . , Z₁₄}, namely, N=15, and set M=2 for sampling the expansion coefficients ai in Section S2.

Given the discrete version of the input function u(⋅), i.e., [u(x₁), . . . , u(xₘ)]^{T}, the evaluation point y, and the fractional order α, the reference solution G(u)(y, α) is computed by using the vector Grünwald-Letnikov formula for approximating Riesz fractional Laplacian. We take 16 Gauss quadrature points for evaluating the integral with respect to differentiation direction and take 2000 finite difference points to approximate fractional directional derivative along a specific differentiation direction.

For DeepONet and CNN models, the raw data are the same. We choose Nᵤ=5000, Nₓ=15×15=225, N_{y}=15×15=225, and N_{α}=10. But the raw data are organized in different ways for the two models. The DeepONet model organizes the data in a loose way, and thus the size of training set is large, namely, Nᵤ×N_{y}×N_{α}=1.125×107. In contrast, the CNN model leverages the spatial structure of the raw data and rearranges the data into a compact form (image). The size of training set is only Nᵤ=5000. Also, the parameters for the test set are the same as those for the training one.

For the CNN, the filter size is fixed to be 3×3, and the maxpooling window size is 2×2. The input images are shaped to be a 4D array having the shape [Nᵤ, Hₓ, Wₓ, 1], where the height (Hₓ) and width (Wₓ) of the image for contour plot of one sample of u(⋅) are taken to be Hₓ=Wₓ=√Nₓ. The output images are arranged to another 4D array having the shape [Nᵤ, H_{y}, W_{y}, N_{α}], where the height (H_{y}) and width (W_{y}) of the images for contour plots of {G(u)(y, α₁), G(u)(y, α₂), . . . , G(u)(y, α_{N}_{_{α}}} are taken to be H_{y}=W_{y}=√N_{y}. We denote by N_{chan} the number of channels in a convolution layer. From the input images to the latent vector, we successively have a convolutional layer with N_{chan}=32, a maxpooling layer, a convolutional layer with N_{chan}=64, and a dense layer with width 64. We take zero padding and stride size 1 for all the above layers. From the latent vector to the output images, we successively have a dense layer with width 64, a dense layer with width 1024 (then reshaped to the shape [Nᵤ, 4, 4, 64]), a convolutional layer with N_{chan}=32, padding size 2, and stride 1 (then upsampled to the shape [Nᵤ, 13, 13, 1]), and a convolutional layer with N_{chan}=N_{α}, padding size 2 and stride size 1. The CNN architecture we just mentioned are rather similar to encoder and decoder in an autoencoder. We borrow the idea of latent space in the autoencoder, and link the two parts in the CNN using the latent space. The dimensionality of the latent space.

S13 Hölder Continuity of the Operators in this Patent

For all the explicit and implicit operators in our examples, the operators G are Hölder continuous.

$${‖ G ( f ) - G ( g ) ‖}_{X} \leq C {‖ f - g ‖}_{Y}^{α} 0 < α \leq 1 .$$

Here C>0 depends on f and g and the operator G. Here we X and Y are Banach spaces and they refers to the space of continuous functions on a compact set unless otherwise stated.

Let G_{N} be the approximated G using DeepONet. Let fₕ be an approximation of f in Y, possibly by collocation or neural networks. Then

$${‖ G ( f ) - {G}_{N} ( {f}_{h} ) ‖}_{X} \leq {‖ G ( f ) - G ( {f}_{h} ) ‖}_{X} + {‖ G ( {f}_{h} ) - {G}_{N} ( {f}_{h} ) ‖}_{X} \leq C {‖ f - {f}_{h} ‖}_{Y}^{α} + ε ,$$

where ε is the user-defined accuracy as in the universal approximation theorem by neural networks and thus the key is to verify the operator G is Hölder continuous.

The explicit operators and their Lipschitz continuity (α=1) are presented below.

1. (Simple ODE, Problem 1.A) G(u)(x)=s₀+∫₀^{x} u(s)ds.

$${max}_{x ϵ [ 0 , b ]} \vert G ( u ) ( x ) - G ( \text{?} ) ( x ) \vert \leq b {max}_{x ϵ [ 0 , b ]} \vert u - v \vert .$$

$$\text{?} \text{indicates text missing or illegible when filed}$$

2. (Caputo derivative, Problem 2) The operator is Lipschitz continuous with respect to its argument in weighted Sobolev norms, c.f. [47, Theorem 2.4].

3. (Integral fractional Laplacian, Problem 3) The operator is Lipschitz continuous with respect to its argument in weighted Sobolev norms, c.f. [14, Theorem 3.3].

4. (Legendre transform, Problem 7 in Equation (S6)). The Lipschitz continuity of the operator G(u)(n)=∫¹₋₁ Pₙ(x)u(x)dx can be seen as follows. For any non-negative integer,

$${max}_{n} \vert G ( u ) ( n ) - G ( v ) ( n ) \vert \leq {max}_{n} {\int }_{- 1}^{1} \vert {P}_{n} ( x ) \vert dx {max}_{x ϵ [ - 1 , 1 ]} \vert u - v \vert \leq C {max}_{x ϵ [ - 1 , 1 ]} \vert u - v \vert \\ where C = {max}_{n} {( {\int }_{- 1}^{1} dx )}^{1 / 2} {( {\int }_{- 1}^{1} {\vert {P}_{n} ( x ) \vert}^{2} dx )}^{1 / 2} = {{max}_{n} ( 2 \frac{2}{2 n + 1} )}^{1 / 2} \leq 2.$$

5. The linear operator from Problem 9 in (S7) in Lipschitz continuous with respect to the initial condition in the norm in the space of continuous functions, from the classical theory for linear parabolic equations.

The implicit operators from dynamic systems and differential equations are more complicated. The Hölder continuity of these operators are elaborated in the following text.

The implicit operator from Problem 1. The Lipschitz continuity of the operator has been shown in the proof of Theorem 2. For Problem 1.C, the solution is still bounded as long as the input u is not too large. With a bounded solution s, the nonlinear term s2 is Lipschitz continuous, and thus, the Lipschitz continuity of the operator is still valid, as in the proof of Theorem 2.

The implicit operator from Problem 4 is Lipschitz with respect to the right-hand side u of not large values, from the classical theory for quasi-linear parabolic equations.

The implicit operator from Problem 5. dy(t, ω)=k(t, ω)y(t, ω) dt, y(0)=y0. Here k(t) is a Gaussian process with mean zero and a smooth covariance function. The exact solution is y=y₀ exp(∫^{t}₀ k(s)ds). Then the solution operator is Lipschitz continuous in the pathwise sense. Let k₁(t) and k₂(t) be the coefficients in Problem 5 and y₁(t) and y₂(t) are the corresponding solutions. By the mean value theorem, |e^{x}−e^{y}|≤|x−y|(e^{x}+e_{y}) holds for all x, y∈R and

$$\vert {y}_{1} ( t ) - {y}_{2} ( t ) \vert = \vert {y}_{0} \vert \vert exp ( {\int }_{0}^{t} {k}_{1} ( s ) ds ) - exp ( {\int }_{0}^{t} {k}_{2} ( s ) ds ) \vert \leq \vert {y}_{0} \vert ( exp ( {\int }_{0}^{t} {k}_{1} ( s ) ds ) + exp ( {\int }_{0}^{t} {k}_{2} ( s ) ds ) \vert {\int }_{0}^{t} {k}_{1} ( s ) - {k}_{2} ( s ) ds \vert \leq \vert {y}_{0} \vert exp ( {\int }_{0}^{t} {k}_{1} ( s ) ds ) + exp ( {\int }_{0}^{t} {k}_{2} ( s ) ds ) {\vert {k}_{1} - {k}_{2} \vert}_{C ( [ 0 , T ] )}$$

Then for any t∈[0, T]

∥G(k₁)(⋅,ω)−G(k₂)(⋅,ω)∥_{C[0,T]}≤C(ω,t)|k₁(⋅,ω)−k₂(⋅,ω)|_{L∞([0,t])},
where C(ω, T)=|y₀|(max_{t∈[0, T]} exp(∫^{t}₀ k₁(s,ω)ds)+max_{t∈[0, T]} exp(∫^{t}₀ k₂(s,ω)ds)) has moments of any order.

The implicit operator from Problem 6. The operator can be written as u=G(b) and uᵢ=G(bᵢ), i=1, 2 satisfy the following equations:

−div(e^{b}^{ᵢ}^{(x)}∇uᵢ)=f(x), x∈D=(0,1), uᵢ(x)=0, x∈∂D,

Then ∥uᵢ(ω)∥_{H}_{¹}≤(min_{x∈D} e^{-bi})⁻¹∥f∥_{H}_{^{−1}}, where H¹ and H⁻¹ are standard Sobolev-Hilber spaces. The difference u₁−u₂ satisfies the following

−div(e^{b}^{₁}^{(x)}∇(u₁−u₂))=div((e^{b}^{₁}^{(x)}−e^{b}^{₂}^{(x)})∇u₂), x∈D, u₁−u₂=0, x∈∂D.

Then by the stability of the elliptic equation, we have

$${‖ {u}_{1} ( ω ) - {u}_{2} ( ω ) ‖}_{{H}^{1}} \leq {( {min}_{x ϵ D} {e}^{{b}_{1} ( x )} )}^{- 1} {‖ ( {e}^{{b}_{1}} - {e}^{{b}_{2}} ) ∇ {u}_{2} ‖}_{{D}^{2}} = {( {min}_{x ϵ D} {e}^{{b}_{1} ( x )} )}^{- 1} {‖ ( {e}^{{b}_{1}} - {e}^{{b}_{2}} ) ‖}_{C ( D )} {‖ {u}_{2} ‖}_{{H}^{1}} \leq {( {min}_{x ϵ D} {e}^{{b}_{1} ( x )} )}^{- 1} {( {min}_{x ϵ D} {e}^{{b}_{2} ( x )} )}^{- 1} {‖ ( {e}^{{b}_{1}} - {e}^{{b}_{2}} ) ‖}_{C ( D )} {‖ f ‖}_{{H}^{- 1}}$$

Then by the mean value theorem

$${‖ {u}_{1} ( ω ) - {u}_{2} ( ω ) ‖}_{{H}_{0}^{1}} \leq {( {min}_{x ϵ D} {e}^{{b}_{1} ( x )} )}^{- 1} {( {min}_{x ϵ D} {e}^{{b}_{2} ( x )} )}^{- 1} ( {‖ {e}^{{b}_{1}} ‖}_{C ( D )} + {‖ {e}^{{b}_{2}} ‖}_{C ( D )} ) {‖ {b}_{1} - {b}_{2} ‖}_{C ( D )} {‖ f ‖}_{{H}^{- 1}} .$$

According to [4, Proposition 2.3], all the random variables

$$‖ 𝒢 ( {b}_{1} ) ( \text{?} ) - 𝒢 ( {b}_{2} ) ( \text{?} ) ‖ \text{?} \leq C ( \text{?} ) ‖ {b}_{1} - {b}_{2} ‖ \text{?} .$$

$$Here C ( \text{?} ) = {( min \text{?} )}^{- 1} {( min \text{?} )}^{- 1} ( ‖ \text{?} ‖ ) \text{?} + ‖ \text{?} ‖ \text{?} ) ‖ f ‖ \text{?}$$

$$\text{?} \text{indicates text missing or illegible when filed}$$

i=1, 2 have any moments of finite order. Then, we obtain the pathwise Lipschitz continuity of the operator G

$${‖ 𝒢 ( {b}_{1} ) ( ω ) - 𝒢 ( {b}_{2} ) ( ω ) ‖}_{{H}^{1}} \leq C ( ω ) {‖ {b}_{1} - {b}_{2} ‖}_{C ( D )} . \\ Here C ( ω ) = {( {min}_{x ϵ D} {e}^{{b}_{1} ( x )} )}^{- 1} {( {min}_{x ϵ D} {e}^{{b}_{2} ( x )} )}^{- 1} ( {‖ {e}^{{b}_{1}} ‖}_{C ( D )} + {‖ {e}^{{b}_{2}} ‖}_{C ( D )} ) {‖ f ‖}_{{H}^{- 1}} .$$

The implicit operator in Problem 8 is also Lipschitz continuous. The solution can be represented as s₀(X⁻¹(t, x)), where X(t, x) satisfies the following equation

X(t,x)=a(t,X(t,x)), X(0,x)=x.

As there exists a₀>0 such that a(t, x)>a₀>0 in the setting of Problem 8, X(t, x)>0 is away from zero. Denote the solution with coefficient a and initial condition u₀ by u₀(X⁻¹) and the solution with coefficient b and initial condition v₀ by v₀(X⁻¹). We then can derive the Lipschitz continuity of the operator from the following facts that

$${u}_{0} ( {X}_{a}^{- 1} ( t , x ) ) - {v}_{0} ( {X}_{b}^{- 1} ) ( t , x ) = ( {u}_{0} ( {X}_{a}^{- 1} ( t , x ) ) - {u}_{0} ( {X}_{b}^{- 1} ( t , x ) ) ) + ( {u}_{0} ( {X}_{a}^{- 1} ( t , x ) ) - {v}_{0} ( {X}_{b}^{- 1} ) ( t , x ) )$$

and that u₀, v₀ are Lipschitz and Xₐ and X⁻¹ (X_{b} and X⁻¹) are Lipchitz continuous with respect to a (b).

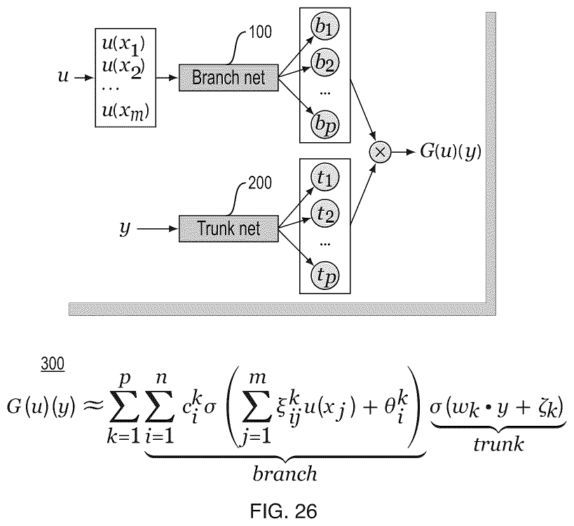

Referring now to FIG. 26, the DeepONet architecture, fully described above, is unique. More specifically, the DeepONet architecture includes two separate neural networks, namely a branch net 100 and a trunk net 200. This DeepONet architecture is based on an underlying mathematical theorem, i.e., the Operator Approximation Theorem 300. The trunk net 200 serves as an adaptive bases and the branch net 100 serves as an adaptive unknown coefficient.

In this study, all our training datasets are obtained from numerical solvers, i.e., the trained DeepONet is a surrogate of the numerical solver. Hence, Deep-ONets cannot be better than the numerical solvers in terms of accuracy. However, the computational cost of running inference of DeepONet is significantly lower than the numerical solver.

More broadly, a DeepONet could represent a multiscale operator trained with data spanning several orders of magnitude in spatio-temporal scales, for example, trained by data from the molecular, mesoscopic and continuum regimes in fluid mechanics or other multiscale problems. We could also envision other types of composite DNNs for developing multiphysics operators, e.g., in electro-convection involving the evolution of the flow field and concentration fields of anions and cations due to continuous variation of imposed electric potentials. Indeed, in ongoing work, we have developed an extension of DeepONet for simulating this electro-convection multiphysics problem [8], where we show that DeepONet is significantly faster than a spectral element solver. We have obtained a similar speed-up and high accuracy in hypersonics for learning the aerodynamics coupled with the finite rate chemistry of multiple species. Learning such multiscale and multiphysics nonlinear operators will simplify computational modeling and will facilitate very fast predictions of complex dynamics for unseen new parameter values and new input functions (boundary/initial conditions/excitation) with good accuracy, if the generalization error is bounded.

This architecture is linked to several benefits. For example, a generalization capability. Generalization here means to extrapolate outside the region of seen (training) data. This ability is due to the feature expansion in the Branch net and the extra overparameterization in Trunk net.

Incorporating the physics: This is possible because of the trunk net 200 (derivatives with respect to trunk net 200 input, y). Other state-of-the-art architectures such as LSTM (long short-term memory) networks do not have this capability because they don't have the trunk net 200.

Less data demanding: This is because we can add the physics and replace the physical model with some previously required data.

Adaptivity to non-uniform, incomplete, and scattered dataset: The trunk net 200 enables DeepONet to be trained and predict the output on scattered datasets unlike the existing state-of-the-art architectures.

The DeepONet architecture may be applied to many different applications. For example, it may be applied to forecasting applications. More specifically, airfoils, solar thermal systems, VIV, material damage, path planning, material processing applications, additive manufacturing, structural health monitoring and infiltration.

The DeepONet architecture may be applied to design applications. More specifically, airfoils, material damage and structural health monitoring.

The DeepONet architecture may be applied to control/autonomy applications. More specifically, airfoils, electro-convection and path planning.

The DeepONet architecture may be applied to identification/discovery. More specifically, VIV, material damage and electro-convention.

The DeepONet architecture may be applied to resin transfer molding (RTM).

It would be appreciated by those skilled in the art that various changes and modifications can be made to the illustrated embodiments without departing from the spirit of the present invention. All such modifications and changes are intended to be within the scope of the present invention except as limited by the scope of the appended claims.

What is claimed is:

1. A method of operating a neural network device comprising:
constructing two sub-networks to encode input functions and space-time variables separately; and
merging the two constructed sub-networks together to compute output functions that depend on space time.

2. A network comprising:
a first neural network configured to encode a discrete function space on a structured or unstructured space-time domain; and
a second neural network configured to encode a domain of output functions.

3. A network comprising:
multiple DeepONets configured together to represent one of a plurality of multiphysics problems.

4. The network of claim 3 wherein the one of the plurality of multiphysics problems comprises forecasting, the forecasting comprising predicting a time and a space of a state of a system.

5. The network of claim 3 wherein the one of the plurality of multiphysics problems comprises interrogating a system with different input scenarios to optimize design parameters of the system.

6. The network of claim 3 wherein the one of the plurality of multiphysics problems comprises actuating a system to achieve efficiency/autonomy.

7. The network of claim 3 wherein the one of the plurality of multiphysics problems comprises identifying system parameters and discovering unobserved dynamics.

8. The network of claim 3 wherein the one of the plurality of multiphysics problems comprises forecasting applications.

9. The network of claim 8 wherein the forecasting applications include airfoils, solar thermal systems, VIV, material damage, path planning, material processing applications, additive manufacturing, structural health monitoring and infiltration.

10. The network of claim 3 wherein the one of the plurality of multiphysics problems comprises design applications.

11. The network of claim 10 wherein the design applications include airfoils, material damage and structural health monitoring.

12. The network of claim 3 wherein the one of the plurality of multiphysics problems comprises control/autonomy applications.

13. The network of claim 12 wherein the control/autonomy applications include airfoils, electro-convection and path planning.

14. The network of claim 3 wherein the one of the plurality of multiphysics problems comprises identification/discovery applications.

15. The network of claim 14 wherein the identification/discovery applications include VIV, material damage and electro-convention.

16. The network of claim 3 wherein the one of the plurality of multiphysics problems comprises resin transfer molding (RTM) applications.
